(19) United States
(12) Patent Application Publication
(10) Pub. No.: US 2018/0115975 A1
(43) Pub. Date: Apr. 26, 2018

(54) RADIO BASE STATION, USER TERMINAL AND RADIO COMMUNICATION METHOD

(71) Applicant: NTT DOCOMO, INC., Tokyo (JP)

(72) Inventors: Kazuki Takeda, Tokyo (JP); Hiroki Harada, Tokyo (JP); Satoshi Nagata, Tokyo (JP); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 15/524,376

(22) PCT Filed: Oct. 9, 2015
(86) PCT No.: PCT/JP2015/078745

§ 371 Date: May 4, 2017

(30) Foreign Application Priority Data
Nov. 6, 2014 (JP) 2014-226330

(51) Int. Cl. H04W 72/04; H04W 72/12; H04L 5/00; H04L 1/18

(52) U.S. Cl. CPC H04W 72/0453; H04W 72/042; H04W 72/12; H04W 88/12; H04L 1/1812; H04L 1/1854; H04L 5/0053

(57) ABSTRACT

The present invention is designed to reduce the deterioration of communication quality even when listening-based transmission control is applied to the downlink. The present invention provides a transmission section that transmits delivery acknowledgment signals in response to UL data that is transmitted from a user terminal, and a control section that controls the transmission of the delivery acknowledgment signals based on the results of listening in downlink, when transmission of a delivery acknowledgment signal is not limited based on a result of listening, the control section controls the transmission of the delivery acknowledgment signal at a predetermined transmission timing, and, when transmission of a delivery acknowledgment signal in a subframe i is limited based on a result of listening, controls the delivery acknowledgment signal that is limited from being transmitted to be transmitted in a predetermined subframe in which, after the subframe i, a delivery acknowledgment signal can be transmitted.

### TECHNICAL FIELD

The present invention relates to a radio base station, a user terminal and a radio communication method that are applicable to next-generation communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). In LTE, as multiple-access schemes, a scheme that is based on OFDMA (Orthogonal Frequency Division Multiple Access) is used in downlink channels (downlink), and a scheme that is based on SC-FDMA (Single Carrier Frequency Division Multiple Access) is used in uplink channels (uplink). Also, successor systems of LTE (also referred to as, for example, “LTE-advanced” or “LTE enhancement” (hereinafter referred to as “LTE-A”)) have been developed for the purpose of achieving further broadbandization and increased speed beyond LTE, and the specifications thereof have been drafted (Re. 10/11).

In relationship to LTE-A systems, a HetNet (Heterogeneous Network), in which small cells (for example, pico cells, femto cells and so on), each having local a coverage area of a radius of approximately several tens of meters, are formed within a macro cell having a wide coverage area of a radius of approximately several kilometers, is under study. Also, in relationship to HetNets, a study is in progress to use carriers of different frequency bands between macro cells (macro base stations) and small cells (small base stations), in addition to carriers of the same frequency band.

Furthermore, for future radio communication systems (Rel. 12 and later versions), a system (“LTE-U” (LTE Unlicensed)) to run LTE systems not only in frequency bands licensed to communications providers (operators) (licensed bands), but also in frequency bands where license is not required (unlicensed bands), is under study. In particular, a system that runs an unlicensed band on the premise that a licensed band is present (LAA: Licensed-Assisted Access) is also under study. Note that systems that run LTE/LTE-A in unlicensed bands may be collectively referred to as “LAA.” A licensed band is a band in which a specific provider is allowed exclusive use, and an unlicensed band is a band which is not limited to a specific provider, and in which radio stations can be provided.

For unlicensed bands, for example, the 2.4 GHz band and the 5 GHz band where Wi-Fi (registered trademark) and Bluetooth (registered trademark) can be used, and the 60 GHz band where millimeter-wave radars can be used are under study for use. Studies are in progress to use these unlicensed bands in small cells.

### CITATION LIST

### Non-Patent Literature

Non-Patent Literature 1: 3GPP TS 36. 300 “Evolved UTRA and Evolved UTRAN Overall Description”

### SUMMARY OF INVENTION

### Technical Problem

The premise of existing LTE/LTE-A is that it is run in licensed bands, and therefore each operator is allocated a different frequency band. However, unlike a licensed band, an unlicensed band is not limited to use by a specific provider. Furthermore, unlike a licensed band, an unlicensed band is not limited to use in a specific radio system (for example, LTE, Wi-Fi, etc.). Consequently, there is a possibility that the frequency band which a given operator uses in LAA overlaps the frequency band which another operator uses in LAA and/or Wi-Fi.

An unlicensed band may be run without even synchronization, coordination and/or cooperation between different operators and/or non-operators. Furthermore, different operators and/or non-operators may set up radio access points (also referred to as “APs,” “TPs,” etc.) and/or radio base stations (eNBs) without even coordinating and/or cooperating with each other. In this case, detailed cell planning is not possible, and interference control is not possible, and therefore there is a threat that significant cross-interference is produced in the unlicensed band, unlike a licensed band.

Consequently. when an LBT/LTE-A system (LTE-U) is run in an unlicensed band, it is desirable if the LBT/LTE-A system operates taking into account the cross-interference with other systems that run in this unlicensed band, such as Wi-Fi, LTE-U under other operators, and so on. In order to prevent cross-interference in unlicensed bands, a study is in progress to allow an LTE-U base station/user terminal to perform “listening” before transmitting a signal and check whether other base stations/user terminals are communicating. This listening operation is also referred to as “LBT” (Listen Before Talk).

However, when a radio base station/user terminal controls transmission (for example, determines whether or not transmission is possible) based on LBT results, there is a threat of limiting signal transmission depending on LBT results, and being unable to transmit signals at predetermined timings. In this case, signal delays, signal disconnections and/or cell detection failures occur in LTE-U, resulting in a deterioration of signal quality.

For example, in an LTE/LTE-A system, the radio base station transmits retransmission acknowledgment signals (also referred to as “HARQ-ACKs” or “A/Ns”) in response to UL data that is transmitted from user terminals, at predetermined timings. However, if DL transmission is limited due to the result of LBT on the downlink (DL-LBT), there is a threat of making the radio base station unable to transmit retransmission acknowledgment signals at predetermined timings. As a result, user terminals are unable to learn the status of receipt of UL data in the radio base station adequately, which then raises a fear of damaging the quality of communication.

The present invention has been made in view of the above, and it is therefore an object of the present invention to provide a radio base station, a user terminal and a radio communication method that can reduce the deterioration of communication quality even when listening-based transmission control is applied to the downlink.

### Solution to Problem

One aspect of the present invention provides a radio base station having a transmission section that transmits delivery acknowledgment signals in response to UL data that is transmitted from a user terminal, and a control section that controls the transmission of the delivery acknowledgment signals based on the results of listening in downlink, and, in this radio base station, when transmission of a delivery acknowledgment signal is not limited based on a result of listening, the control section controls the transmission of the delivery acknowledgment signal at a predetermined transmission timing, and, when transmission of a delivery acknowledgment signal in a subframe i is limited based on a result of listening, controls the delivery acknowledgment signal that is limited from being transmitted to be transmitted in a predetermined subframe in which, after the subframe i, a delivery acknowledgment signal can be transmitted.

### Advantageous Effects of Invention

According to one aspect of the present invention, it is possible to reduce the deterioration of communication quality even when listening-based transmission control is applied to the downlink.

### BRIEF DESCRIPTION OF DRAWINGS

FIG. 1 is a diagram to show examples of modes of operation in the event LTE is run using an unlicensed band;

FIG. 2 is a diagram to show an example of a mode of operation in the event LTE is run using an unlicensed band;

FIG. 3 is a diagram to show an example of transmission control for use when listening (LBT) is used;

FIG. 4 provide diagrams to explain HARQ-ACK timings in each TDD UL/DL configuration;

FIG. 5 is a diagram to explain a case where UL HARQ-ACK transmission is limited due to the result of LBT;

FIG. 6 is a diagram to show an example of a UL HARQ-ACK transmission method that takes LBT results into consideration;

FIG. 7 is a diagram to show another example of a UL HARQ-ACK transmission method that takes LBT results into consideration;

FIG. 8 provide diagrams to explain reference signals (BRSs) that are based on the result of DL-LBT;

FIG. 9 is a diagram to show another example of a UL HARQ-ACK transmission method that takes LBT results into consideration;

FIG. 10 is a diagram to show another example of a UL HARQ-ACK transmission method that takes LBT results into consideration;

FIG. 11 is a diagram to show another example of a UL HARQ-ACK transmission method that takes LBT results into consideration;

FIG. 12 is a diagram to show another example of a UL HARQ-ACK transmission method that takes LBT results into consideration;

FIG. 13 provide diagrams to explain a method of allocation to HARQ-ACK PHICH resources;

FIG. 14 is a diagram to explain an example of a method of allocation to HARQ-ACK PHICH resources that takes LBT results into consideration;

FIG. 15 provide diagram to explain another example of a method of allocation to HARQ-ACK PHICH resources that takes LBT results into consideration;

FIG. 16 provide diagram to explain another example of a method of allocation to HARQ-ACK PHICH resources that takes LBT results into consideration;

FIG. 17 provide diagrams to explain another example of a method of allocation to HARQ-ACK PHICH resources that takes LBT results into consideration;

FIG. 18 is a schematic diagram to show an example of a radio communication system according to the present embodiment;

FIG. 19 is a diagram to explain an overall structure of a radio base station according to the present embodiment;

FIG. 20 is a diagram to explain a functional structure of a radio base station according to the present embodiment;

FIG. 21 is a diagram to explain an overall structure of a user terminal according to the present embodiment; and

FIG. 22 is a diagram to explain a functional structure of a user terminal according to the present embodiment.

### DESCRIPTION OF EMBODIMENTS

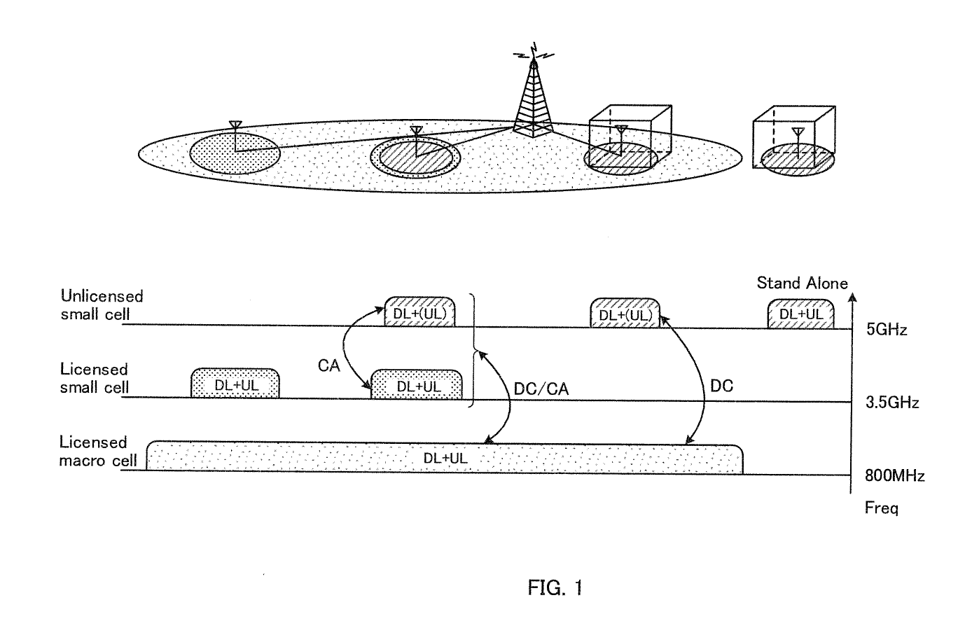

FIG. 1 shows an example of an operation mode of a radio communication system (LTE-U) that runs LTE in an unlicensed band. As shown in FIG. 1, there may be a plurality of possible scenarios to use LTE in an unlicensed band, such as carrier aggregation (CA), dual connectivity (DC) and stand-alone (SA).

FIG. 1 shows a case where a macro cell to use a licensed band (for example, the 800 MHz hand), small cells to use a licensed band (for example, the 3.5 GHz band) and small cells to use an unlicensed band (for example, the 5 GHz band) are provided. The frequency bands to use and the cell size where the unlicensed bands are configured are by no means limited to those illustrated.

In this case, a scenario to apply CA and/or DC among the macro cell to use a licensed band (licensed macro cell), the small cells to use a licensed band (licensed small cells) and the small cells to use an unlicensed band (unlicensed small cells) may be possible.

For example, carrier aggregation (CA) can be executed by using a licensed band and an unlicensed band. FIG. 1 shows a case in which the macro cell and/or the small cells using licensed bands, and the small cells using an unlicensed band employ CA. CA is a technique to bundle a plurality of frequency blocks (also referred to as “component carriers” (CCs), “cells,” etc.) into a wide band. When CA is employed, one radio base station's scheduler controls the scheduling of a plurality of CCs. Based on this, CA may be referred to as “intra-base station CA” (intra-eNB CA).

In this case, the small cells to use an unlicensed band may use a carrier for exclusive use for DL communication, or use TDD to carry out both UL communication and DL communication. Note that FDD and/or TDD can be used in the licensed bands.

Furthermore, a (co-located) structure may be employed here in which a licensed band and an unlicensed band are transmitted and received via one transmitting/receiving point (for example, a radio base station). In this case, the transmitting/receiving point can communicate with user terminals by using both the licensed band and the unlicensed band. Alternatively, it is equally possible to employ a (non-co-located) structure in which a licensed band and an unlicensed band are transmitted and received via different transmitting/receiving points (for example, one via a radio base station and the other one via an RRH (Remote Radio Head) that is connected with the radio base station).

Also, dual connectivity (DC) can be executed by using a licensed band and an unlicensed band. FIG. 1 illustrates a case where the macro cell to use a licensed band and small cells to use unlicensed bands employ DC. Also, it is equally possible to apply DC among the macro cell and a small to use a licensed band, and a small cell to use an unlicensed band. DC is the same as CA in bundling a plurality of CCs (or cells) into a wide band. CA holds the premise that CCs (or cells) are connected via ideal backhaul and is capable of coordinated control that produces very little delay time. By contrast with this, DC presumes cases in which cells are connected via non-ideal backhaul, which produces delay time that is more than negligible.

Consequently, in dual connectivity, cells are run by separate base stations, and user terminals communicate by connecting with cells (or CCs) that are run by different base stations in different frequencies. So, when dual connectivity is employed, a plurality of schedulers are provided individually, and these multiple schedulers each control the scheduling of one or more cells (CCs) managed thereunder. Based on this, dual connectivity may be referred to as “inter-base station CA” (inter-eNB CA). Note that, in dual connectivity, carrier aggregation (intra-eNB CA) may be employed per individual scheduler (that is, base station) that is provided.

The small cells to use an unlicensed band can use a carrier that is used for DL communication only. Alternatively, TDD to carry out both UL communication and DL communication may be used. Note that the macro cell to use a licensed band can use FDD and/or TDD.

Furthermore, stand-alone (SA), in which a cell to run LTE by using an unlicensed band operates alone, may be used as well. Stand-alone here means that communication with terminals is possible without employing CA or DC. In this case, a user terminal can establish an initial connection with an LTE-U base station. In stand-alone, an unlicensed band may be run in TDD.

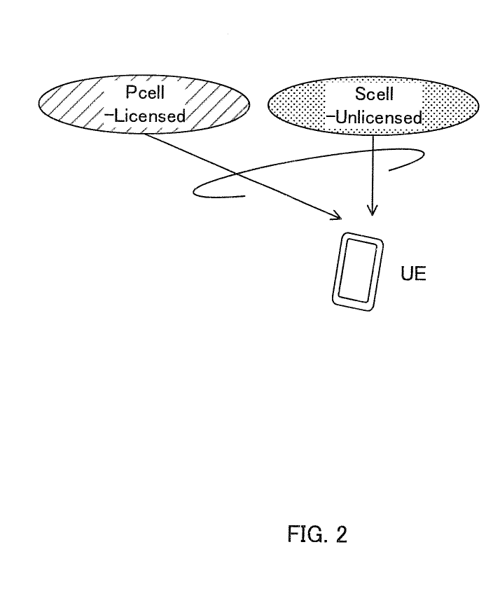

In the operation modes of CA/DC described above, for example, it is possible to use a licensed band CC as the primary cell (PCell) and an unlicensed band CC as a secondary cell (SCell) (see FIG. 2). The primary cell (PCell) refers to the cell that manages RRC connection, handover and so on when CA/DC is used, and is also a cell that requires UL communication in order to receive data and feedback signals from terminals. The primary cell is always configured in both the uplink and the downlink. A secondary cell (SCell) refers to another cell that is configured apart from the primary cell when CA/DC is employed. A secondary cell may be configured in the downlink alone, or may be configured in both the uplink and the downlink at the same time.

Note that, as shown with the operation modes of CA/DC, a mode to presume the presence of licensed-band LTE (licensed LTE) when running LTE-U is referred to as “LAA” (Licensed-Assisted Access) or “LAA-LTE.” In LAA, licensed band LTE and unlicensed band LTE are coordinated to allow communication with user terminals. In LAA, a transmission point (for example, a radio base station eNB) to use a licensed band and a transmission point to use an unlicensed band can be connected via a backhaul link (for example, optical fiber, the X2 interface and so on) when being a distance apart.

Now, the premise of existing LTE/LTE-A is that it is run in licensed bands, and therefore each operator is allocated a different frequency band. However, unlike a licensed band, an unlicensed band is not limited to use by a specific provider. When run in an unlicensed band, LTE may be carried out without even synchronization, coordination and/or cooperation between different operators and/or non-operators. In this case, a plurality of operators and/or systems share and use the same frequency in the unlicensed band, and therefore there is a threat of producing cross-interference.

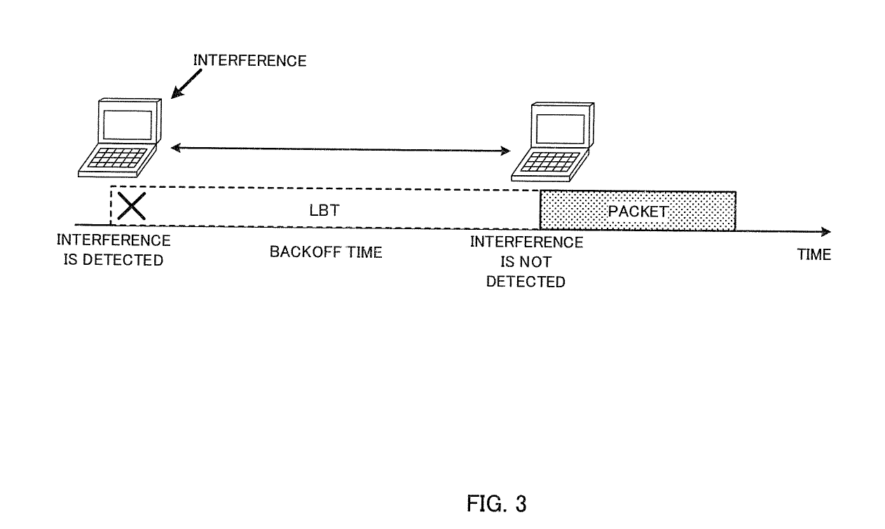

Consequently, in Wi-H systems that are run in unlicensed bands, carrier sense multiple access/collision avoidance (CSMA/CA), which is based on the mechanism of LBT (Listen Before Talk), is employed. To be more specific, for example, a method, in which each transmission point (TP), access point (AP), Wi-Fi terminal (STA: Station) and so on perform “listening” (CCA: Clear Channel Assessment) before carrying out transmission, and carries out transmission only when there is no signal beyond a predetermined level, is used. When there is a signal to exceed a predetermined level, a waiting time is provided, which is determined on a random basis, and, following this, listening is performed again (see FIG. 3).

So, a study is in progress to apply transmission control that is based on the result of listening to LTE/LTE-A systems (for example, LAA) that are run in unlicensed bands. Note that, in the present description, “listening” refers to the operation which a radio base station and/or a user terminal performs before transmitting signals in order to check whether or not signals to exceed a predetermined level (for example, predetermined power) are being transmitted from other transmission points. Also, the “listening” that is performed by radio base stations and/or user terminals may be referred to as “LBT” (Listen Before Talk), “CCA” (Clear Channel Assessment) and so on. In the following description, the listening that is performed by user terminals will be referred to simply as “LBT.”

For example, a radio base station and/or a user terminal perform listening (LBT) before transmitting signals in an unlicensed band cell, and checks whether other systems (for example, Wi-Fi) and/or other operators are communicating. If, as a result of listening, the received signal intensity from other systems and/or other LAA transmission points is equal to or lower than a predetermined value, the radio base station and/or the user terminal judges that the channel is in the idle state (LBT_idle), and transmits signals. On the other hand, if, as a result of listening, the received signal intensity from other systems and/or other LAA transmission points is greater than a predetermined value, the radio base station and/or the user terminal judges that the channel is in the busy state (LBT_busy), and limits signal transmission. As to how to limit signal transmission, making a transition to another carrier by way of DFS (Dynamic Frequency Selection), applying transmission power control (TPC), or holding (stopping) transmission may be possible. In the following description, cases in which signal transmission is limited by way of holding (stopping) signal transmission will be described as examples.

In this way, by applying LBT to communication in an LTE/LTE-A system (for example, LAA) that is run in an unlicensed band, it becomes possible to reduce the interference with other systems. However, the present inventors have found that applying LBT-based transmission control methods to existing LTE/LTE-A systems on an as-is basis raises a threat of damaging the quality of communication.

For example, a case may be assumed in which, when LBT is executed in the DL, retransmission control (uplink retransmission control (UL Hybrid ARQ)) is applied to uplink signals that are transmitted from user terminals.

In existing LTE/LTE-A, a radio base station transmits delivery acknowledgment signals (also referred to as “HARQ-ACKs” or “A/Ns”) based on the result of receipt of uplink signals (for example, the PUSCH) transmitted from user terminals. Also, the radio base station transmits delivery acknowledgment signals in response to uplink signals, at predetermined timings, by using the PHICH (Physical Hybrid-ARQ Indicator Channel). When FDD is used, the radio base station feeds back an HARQ-ACK 4 ms after a UL signal is received. Also, when TDD is used, the radio base station feeds back HARQ-ACKs based on HARQ-ACK timings, which are provided in advance per UL/DL configuration.

However, when LBT (DL-LBT) is executed in DL, cases might occur where DL transmission is limited in the radio base station depending on the result of LBT (LBT_busy). In such cases, the radio base station is unable to transmit delivery acknowledgment signals in the HARQ-ACK timings used in existing LTE/LTE-A (for example, a licensed band). Now, an example will be described below, in which uplink retransmission control to use the HARQ-ACK timings stipulated in LTE/LTE-A is applied to a carrier where LBT is configured (using TDD).

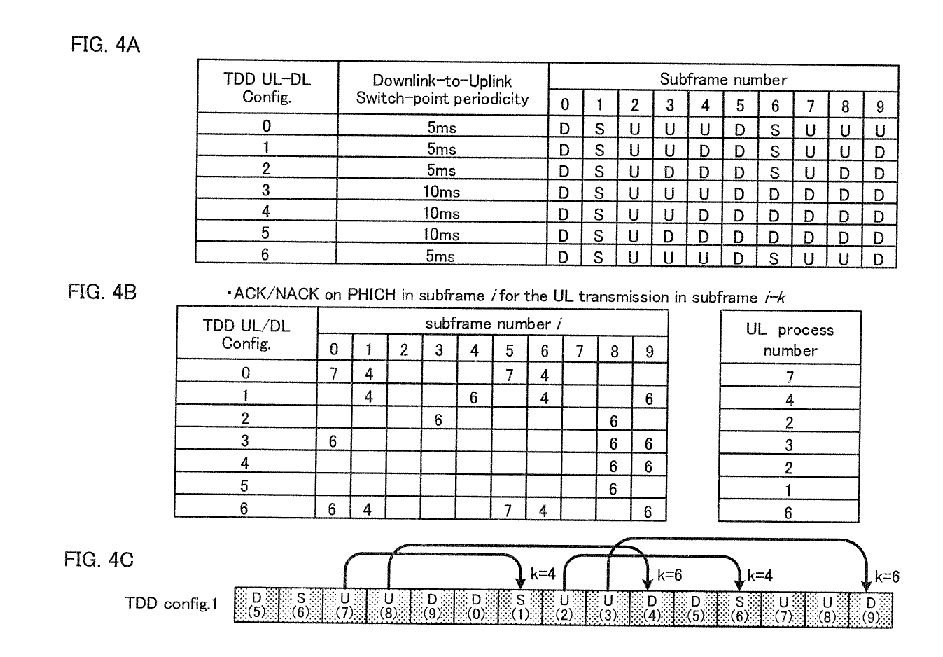

In TDD used in LTE/LTE-A, a plurality of frame configurations (UL/DL configurations) with varying transmission ratios of UL subframes and DL subframes are stipulated (see FIG. 4A). In LTE/LTE-A up to Rel. 11, seven frame configurations—namely, UL/DL configurations 0 to 6—are stipulated. Also, in UL/DL configurations 0, 1, 2 and 6, the periodicity of the point of switching from DL subframes to UL subframes is 5 ms, and, in UL/DL configuration 3, 4 and 5, the periodicity of the point of switching from DL subframes to UL subframes is 10 ms.

Also, the UL subframes to correspond to the delivery acknowledgment signals (HARQ-ACKs) to transmit in each DL subframe/special subframe are defined per UL/DL configuration (see FIG. 4B). That is, the DL subframe to feed back an HARQ-ACK in response to each UL subframe's UL signal is determined based on the table of FIG. 4B. In the DL subframe/special subframe of subframe index i, the radio base station transmits a delivery acknowledgment signal in response to an uplink shared channel (PUSCH) that is transmitted from a user terminal in the UL subframe of subframe index i-k. Here, k assumes the numbers shown in the table of FIG. 4B.

For example, in the event of UL/DL configuration 1, the radio base station transmits a delivery acknowledgment signal in response to the PUSCH that is received in the UL subframe of subframe index 7 (k=4), in the special subframe of subframe index 1 (see FIG. 4C). Also, in the DL subframe of subframe index 4, the radio base station transmits a delivery acknowledgment signal in response to the PUSCH received in the UL subframe of subframe index 8 (k=6). Similarly, in the DL subframes of subframe indices 6 and 9, the radio base station transmits delivery acknowledgment signals in response to the PUSCHs received in the UL subframes of subframe indices 2 and 3, respectively.

Note that, in LTE, a plurality of different HARQ processes (UL HARQ processes) can be conducted separately, in parallel, in order to prevent delaying the processing due to HARQ-induced combining/retransmission processes. The radio base station divides the data buffer memory into the maximum number of HARQ processes, buffers received data in varying HARQ process memories depending on which HARQ process numbers the received data corresponds to, and applies HARQ. The number of HARQ processes relies upon the time until the same HARQ process number can be re-used (the time it takes to receive a delivery acknowledgment signal and detect the decision “OK”) (HARQ round trip time). For this reason, in TDD, the maximum number of HARQ processes varies per UL/DL configuration. For example, the maximum number of HARQ processes in uplink retransmission control (UL hybrid ARQ) is seven (when UL/DL configuration 0 is used).

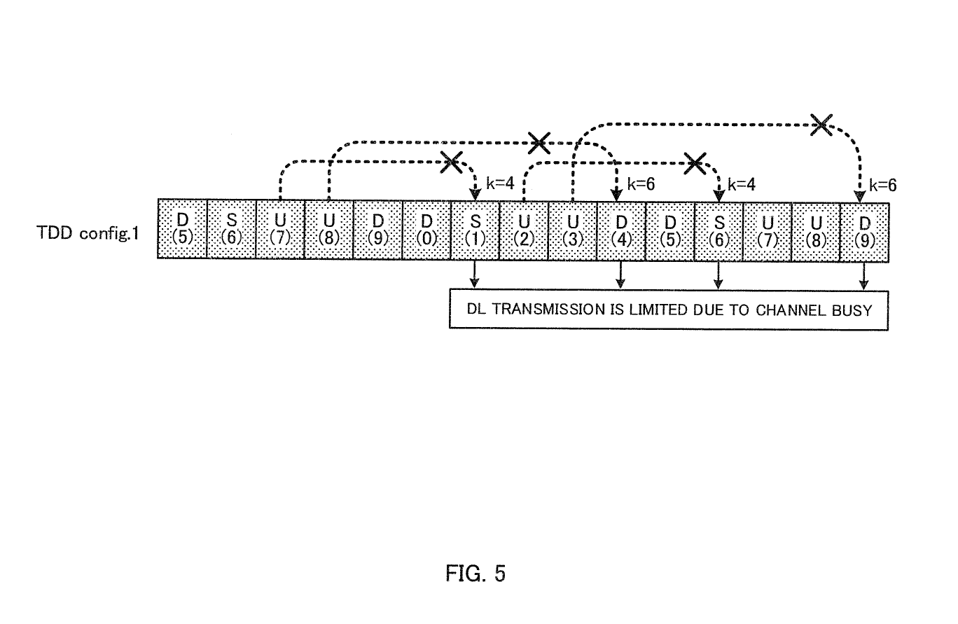

Now, as mentioned earlier, when DL-LBT is used, cases occur where DL subframes cannot be used (LBT_busy) depending on the result of LBT. In this case, as shown in FIG. 4B, the radio base station is unable to transmit HARQ-ACKs at predetermined timings that are provided in advance. For example, the result of DL-LBT yields LBT_busy while UL/DL configuration 1 is applied, the radio base station is limited from making transmission in DL subframes and/or special subframes (part or all of SFs #0, #1, #4 to #6 and #9). By this means, the radio base station is unable to adequately feed back HARQ-ACKs to user terminals (see FIG. 5).

Also, when DL-LBT is executed, subframes to execute DL-LBT (also referred to as “LBT subframes,” “sensing subframes,” etc.) are configured. There is even a possibility that the PHICH cannot be allocated in LBT subframes. In this case, the radio base station is unable to transmit delivery acknowledgment signals at predetermined timings, and therefore a user terminal is unable to judge whether or not UL data which the user terminal has transmitted has been properly received on the radio base station end. In this case, even when the UL data has been received properly, the PHICH is nevertheless not transmitted, and therefore there is a possibility that the user terminal carries out the UL data retransmission operation. In this case, there is a threat of lowering the uplink throughput and damaging the quality of communication.

So, the present inventors have found out that, by controlling the timings of uplink retransmission control based on the result of LBT, delivery acknowledgment signals can be transmitted adequately even when DL transmission is controlled by using DL-LBT. For example, according to one example of the present embodiment, when DL transmission is limited based on the result of DL-LBT (LBT_busy), the timings to transmit delivery acknowledgment signals to user terminals are controlled to be delayed.

Also, when delivery acknowledgment signals cannot be transmitted in DL subframes to perform DL-LBT (LBT subframes), the timings to feed back delivery acknowledgment signals to user terminals are controlled to be delayed. Note that a subframe and/or an area where PHICH allocation is not limited may be used as a subframe for performing DL-LBT. A subframe and/or an area where PHICH allocation is not limited refer to a UL subframe or an area in a DL subframe/special subframe where the PHICH is not placed. In this case, the radio base station can control the timings to transmit delivery acknowledgment signals to user terminals based on the result of LBT.

Also, when CA is executed by using an LBT-configured carrier and a non-LBT-configured carrier, HARQ-ACKs in the LBT-configured carrier may be controlled to be transmitted by using the PHICH of the non-LBT-configured carrier (for example, the PCell). Meanwhile, when DC is executed by using an LBT-configured carrier and a non-LBT-configured carrier DC, or when LBT is applied to stand-alone, it is preferable to control the timings of uplink retransmission control based on the result of LBT. Obviously, when CA is executed by using an LBT-configured carrier and a non-LBT-configured carrier, it is equally possible to control the timings of uplink retransmission control based on the result of LBT and make transmission by using the LBT-configured carrier's PHICH.

Now, an embodiment of the present invention will be described in detail below with reference to the accompanying drawings. Note that, although, in the following description, cases to apply LBT to TDD DL will be described as examples, the present embodiment is by no means limited to these. Also, although the following description will be given assuming that a licensed band is a carrier where LBT is not configured and an unlicensed band is a carrier where LBT is configured, the present embodiment is by no means limited to this. For example, a licensed band may as well be a carrier where LBT is configured. That is, the present embodiment is applicable to any carrier in which LBT is configured, regardless of whether this carrier is a licensed band or an unlicensed band.

Also, although cases will be shown in the following description where a carrier where LBT is configured uses TDD, the present embodiment is by no means limited to this. For example, the present embodiment is equally applicable even when a carrier where LBT is configured uses FDD.

### FIRST EXAMPLE

A case will be described with a first example where, when DL transmission in a radio base station is limited (LBT_busy) based on the result of DL-LBT, delivery acknowledgment signals (UL HARQ-ACKs), which are limited from being transmitted, are controlled to be delayed by a predetermined timing and transmitted. In the following description, cases where LBT is executed in predetermined radio frame (or half-radio frame) units—to be more specific, cases where the periodicity of LBT (LBT periodicity) is made 5 ms or 10 ms—will be described as examples. Obviously, the periodicity of LBT is by no means limited to this.

(When the Periodicity of LBT=10 ms)

When the periodicity of LBT is the same as a radio frame (10 subframes)—that is, 10 ms—a radio base station can control the transmission timings of delivery acknowledgment signals to be delayed based on the result of DL-LBT, on a per radio frame basis. When DL transmission is not limited (LBT_idle), the radio base station can transmit the delivery acknowledgment signal for each UL subframe at an existing HARQ-ACK timing (see, for example, FIG. 4B). That is, when DL transmission is limited (LBT_busy) based on the result of LBT, the radio base station can control the transmission timings of delivery acknowledgment signals to change.

For example, the radio base station transmits the delivery acknowledgment signal that was going to be transmitted in a subframe (for example, DL subframe i), in which transmission is limited based on the result of LBT (LBT_busy), by using the next or a subsequent subframe. To be more specific, the radio base station controls the delivery acknowledgment signal of DL subframe i to be transmitted in DL subframe in which DL transmission becomes available (LBT_idle), and which may be the next or a subsequent radio frame.

That is, the radio base station controls a delivery acknowledgment signal that cannot be transmitted in a given DL subframe/special subframe i to be delayed by radio frame units (i+n×10 (ms)) and transmitted. Here, n assumes an integer greater than 0, and i assumes the radio frame subframe indices (0 to 9) that constitute one radio frame.

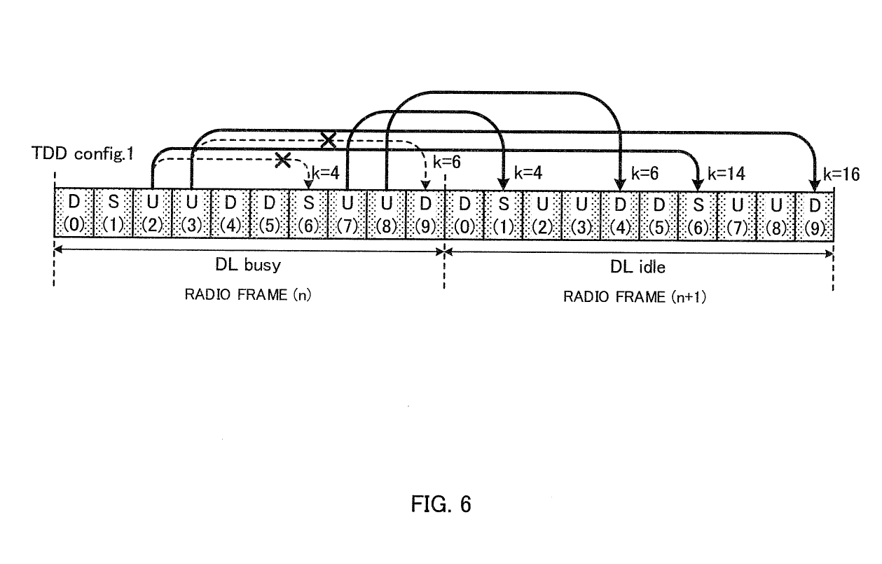

FIG. 6 shows examples of UL HARQ-ACK timings where the periodicity of LBT is made 10 ms, in TDD in which UL/DL configuration 1 is employed. Note that FIG. 6 shows the transmission timings of delivery acknowledgment signals in two radio frames (n and n+1), illustrating a case where DL transmission is limited (LBT_busy) in the first radio frame (n) and DL transmission is not limited (LBT_idle) in the second radio frame (n+1).

In the first radio frame (n), the radio base station cannot transmit the delivery acknowledgment signal in response to the PUSCH of the UL subframe (U (2)) in the special subframe (S (6)). Similarly, the delivery acknowledgment signal in response to the PUSCH of the UL subframe (U (3)) cannot be transmitted in the DL subframe (D (9)).

Consequently, the radio base station controls the delivery acknowledgment signal in response to the PUSCH of the UL subframe (U (2)) of the first radio frame (n) to be transmitted in the special subframe (S (6)) in the second radio frame (n+1). Similarly, the radio base station controls the delivery acknowledgment signal in response to the PUSCH of the UL subframe (U (3)) of the first radio frame (n) to be transmitted in in the DL subframe (D (9)) in the second radio frame (n+1).

Note that the delivery acknowledgment signal in response to the PUSCH of the UL subframe (U (7)) of the first radio frame (n) is transmitted in the second radio frame (n+1), which yields LBT_idle. Consequently, based on the above-noted table shown in FIG. 4B, the radio base station transmits the delivery acknowledgment signal in response to the PUSCH of the UL subframe (U (7)) of the first radio frame (n) in the special subframe (S (1)) in the second radio frame (n+1). Similarly, the radio base station transmits the delivery acknowledgment signal in response to the PUSCH of the UL subframe (U (8)) of the first radio frame (n) in the DL subframe (D (4)) of the second radio frame (n+1).

(When LBT Periodicity=5 ms)

When the periodicity of LBT is a half (5 ms) of a radio frame (10 subframes), the radio base station controls the transmission timings of delivery acknowledgment signals to be delayed based on the result of DL-LBT, on a per radio frame basis. Note that, in this case, too, the radio base station controls a delivery acknowledgment signal that cannot be transmitted in a given DL subframe/special subframe i to be delayed by radio frame units (i+n×10 (ms)) and transmitted.

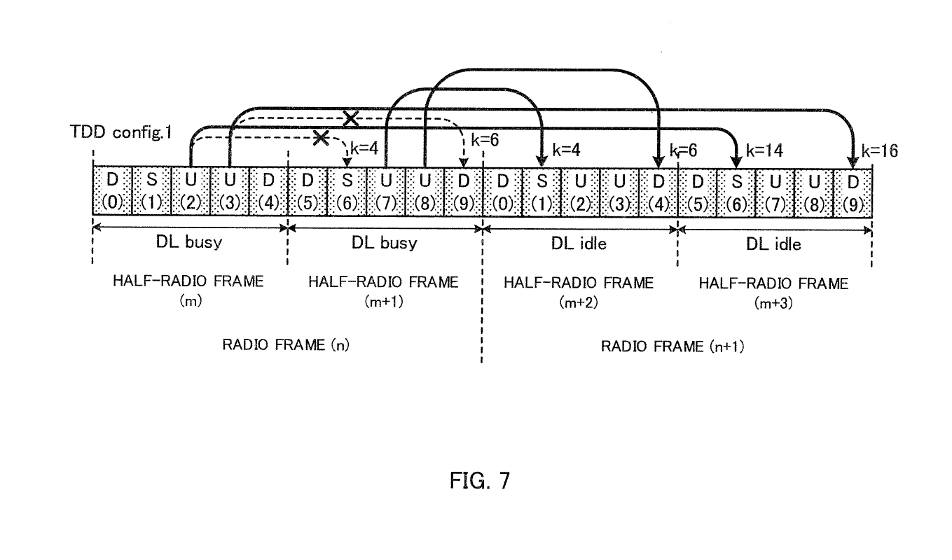

FIG. 6 shows examples of UL HARQ-ACK timings where the periodicity of LBT is made 5 ms, in TDD in which UL/DL configuration 1 is employed. Note that FIG. 7 shows the transmission timings of delivery acknowledgment signals in two radio frames (n and n+1), illustrating a case where the first radio frame (n) is formed with half-radio frames (m) and (m+1), and the second radio frame (n+1) is formed with half-radio frames (m+2) and (m+3). Also, here, assume that DL transmission is limited (LBT_busy) in the half-radio frames (m) and (m+1), and DL transmission is not limited (LBT_idle) in the half-radio frames (m+2) and (m+3).

In the half-radio frame (m), the radio base station cannot transmit the delivery acknowledgment signal in response to the PUSCH of the UL subframe (U (2)), in the special subframe (S (6)). Similarly, the delivery acknowledgment signal in response to the PUSCH of the UL subframe (U (3)) cannot be transmitted in the DL subframe (D (9)).

Consequently, the radio base station controls the delivery acknowledgment signal in response to the PUSCH of the UL subframe (U (2)) of the half-radio frame (m) to be transmitted in the special subframe (S (6)) of the half-radio frame (m+3). Similarly, the radio base station controls the delivery acknowledgment signal in response to the PUSCH of the UL subframe (U(3)) of the half-radio frame (m) to be transmitted in the DL subframe (D (9)) of the half-radio frame (n+3).

Note that the delivery acknowledgment signal in response to the PUSCH of the UL subframe (U (7)) of the half-radio frame (m+1) is allocated to the half-radio frame (m+2), which yields LBT_idle. Consequently, based on the above-noted table shown in FIG. 4B, the radio base station transmits the delivery acknowledgment signal in response to the PUSCH of the UL subframe (U (7)) of the half-radio frame (m+1), in the special subframe (S (1)) of the half-radio frame (m+2). Similarly, the radio base station transmits the delivery acknowledgment signal in response to the PUSCH of the UL subframe (U (8)) of the half-radio frame (m+1), in the DL subframe (D (4)) of the half-radio frame (m+2).

<User Terminal Operation>

A user terminal can control the operation for receiving the delivery acknowledgment signals (UL data retransmission control) transmitted from the radio base station based on the result of DL-LBT. For example, when DL-LBT yields the result of LBT_busy (DL transmission is limited), the user terminal can perform receiving processes for the PHICH and so on, assuming that the delivery acknowledgment signals to be transmitted from the radio base station are delayed by a predetermined timing.

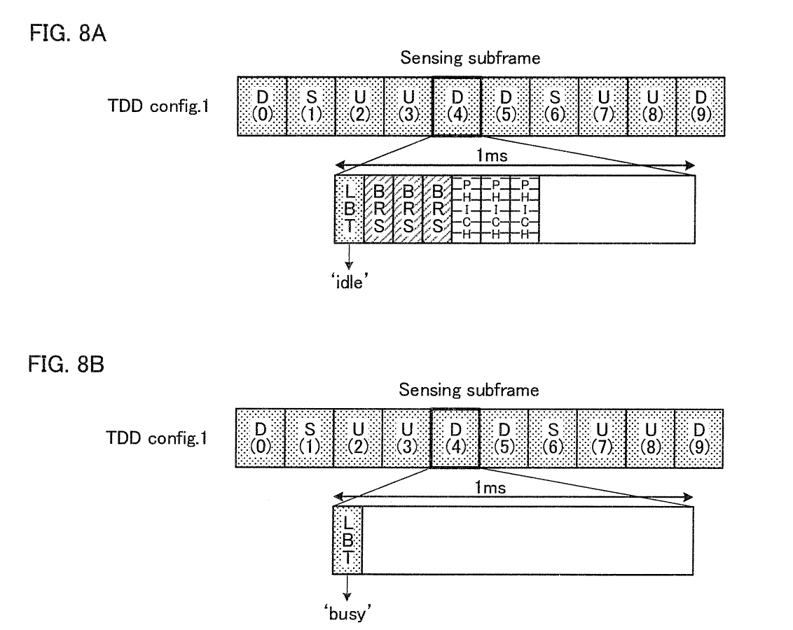

In this case, DL-LBT result is reported to the user terminal, so that the user terminal can decide the DL-LBT result. For example, the radio base station may be structured to transmit a reference signal (BRS: Beacon Reference Signal) when DL-LBT yields the result of LBT_idle (FIG. 8A), and not to transmit a reference signal in the event of LBT_busy (FIG. 8B). In this case, the user terminal can decide the result of LBT based on whether or not a reference signal (BRS) is transmitted from the radio base station and received/detected. For example, the user terminal can decide on LBT_idle when a reference signal (BRS) is detected with received power equal to or greater than a predetermined value, and decide on LBT_busy when no such reference signal is detected. This enables the radio base station and the user terminal to decide on LBT_idle and LBT_busy in unison with each other, so that it is possible to prevent unnecessary detection operations that might be produced when, for example, the radio base station decides on LBT_busy while the user terminal decides on LBT_idle. Also, it is possible to avoid missing detecting DL data and control signals, which might occur when, for example, the radio base station decides on LBT_idle while the user terminal decides on LBT_busy.

In this way, with the first example, when DL-LBT is executed, the delivery acknowledgment signal that is planned to be transmitted in a subframe i, in which DL transmission is limited, is postponed and transmitted in a predetermined subframe (subframe i), in which transmission is possible (LBT_idle), and which may be the next or a subsequent subframe. In particular, by delaying delivery acknowledgment signals on a per radio frame basis, even when a plurality of delivery acknowledgment signals are delayed, it is possible to control the allocation to the PHICH as when existing HARQ-ACK timings are used. By this means, even when DL-LBT is executed, the radio base station can transmit delivery acknowledgment signals adequately, so that it is possible to reduce the deterioration of communication quality.

Also, although cases are shown in FIG. 6 and FIG. 7 where the DL-LBT operation is not carried out in DL subframes (DL subframes are not made LBT subframes), this is by no means limiting. DL-LBT may be executed in predetermined DL subframes. Also, in this case, if the PHICH cannot be allocated in a predetermined DL subframe, the radio base station can transmit the delivery acknowledgment signal that cannot be transmitted in this predetermined DL subframe, with a delay.

### SECOND EXAMPLE

A case will be described with a second example where, when DL transmission is limited (LBT_busy) by DL-LBT, a plurality of delivery acknowledgment signals that are limited from being transmitted, are controlled to be transmitted in a specific subframe, in which DL transmission becomes available (LBT_idle), and which may be the next or a subsequent subframe (or radio frame). Although a case will be shown in the following description where the periodicity of LBT is made 5 ms, the present embodiment is by no means limited to this.

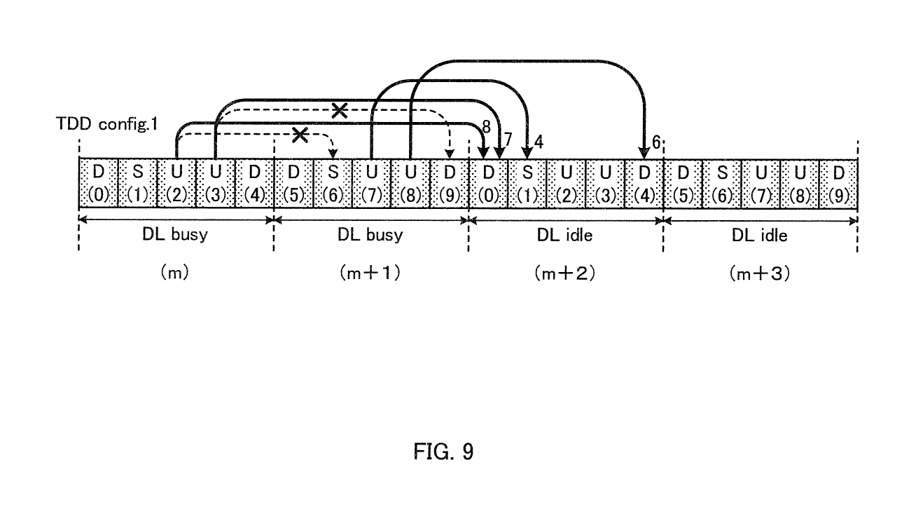

FIG. 6 shows examples of transmission timings of delivery acknowledgment signals where the periodicity of LBT is made 5 ms, in TDD in which UL/DL configuration 1 is employed. Note that FIG. 9 shows the transmission timings of delivery acknowledgment signals in two radio frames. Also, a case is illustrated here in which DL transmission is limited (LBT_busy) in the half-radio frames (m) and (m+1) constituting the first radio frame (n), and DL transmission is not limited (LBT_idle) in the half-radio frames (m+2) and (m+3) constituting the second radio frame (n+1).

When DL transmission is not limited (LBT_idle), the radio base station can transmit the delivery acknowledgment signal For each UL subframe at an existing HARQ-ACK timing (see, for example, FIG. 4B). That is, when DL transmission is limited (LBT_busy) based on the result of LBT, the radio base station can control the transmission timings of delivery acknowledgment signals to change.

In FIG. 9, the radio base station cannot transmit the delivery acknowledgment signal in response to the PUSCH of the UL subframe (U (2)) of the half-radio frame (m) in the special subframe (S (6)). Similarly, the delivery acknowledgment signal in response to the PUSCH of the UL subframe (U (3)) cannot be transmitted in the DL subframe (D (9)).

Consequently, the radio base station controls a plurality of delivery acknowledgment signals that are limited from being transmitted, to be transmitted in a specific subframe, which becomes available for use (for example, the first DL subframe/special subframe), and which may be the next or a subsequent subframe (or the next or a subsequent radio frame). For example, the radio base station can transmit a plurality of delivery acknowledgment signals that are limited from being transmitted, in the first DL subframe/special subframe that yields LBT_idle, which may be the next or a subsequent subframe (or the next or a subsequent radio frame).

In FIG. 9, the radio base station controls the delivery acknowledgment signal in response to the PUSCH of the UL subframe (U (2)) of the half-radio frame (m) to be transmitted in the DL subframe (D (0)) of the half-radio frame (m+2). Similarly, the radio base station controls the delivery acknowledgment signal in response to the PUSCH of the UL subframe (U (3)) of the half-radio frame (m) to be transmitted in the DL subframe (D (0)) of the half-radio frame (m+2).

Note that the delivery acknowledgment signal in response to the PUSCH of the UL subframe (U (7)) of the half-radio frame (m+1) is allocated to the half-radio frame (m+2), which yields LBT_idle. Consequently, based on the above-noted table shown in FIG. 4B, the radio base station transmits the delivery acknowledgment signal in response to the PUSCH of the UL subframe (U (7)) of the half-radio frame (m+1), in the special subframe (S (1)) of the half-radio frame (m+2). Similarly, the radio base station transmits the delivery acknowledgment signal in response to the PUSCH of the UL subframe (U (8)) of the half-radio frame (m+1), in the DL subframe (D (4)) of the half-radio frame (m+2).

In this case, the radio base station controls the transmission timings of delivery acknowledgment signals (PHICH) as in existing LTE/LTE-A in the event of LBT_idle, and has only to change the transmission timings of delivery acknowledgment signal (PHICH) in the event of LBT_busy. Also, since delivery acknowledgment signals that cannot be transmitted in the event of LBT_busy are transmitted in the first DL subframe, in which DL transmission becomes available, and which may be the next or a subsequent subframe, it is possible to reduce the delay of delivery acknowledgment signals.

A user terminal can control the operation for receiving the delivery acknowledgment signals (UL data retransmission control) transmitted from the radio base station based on the result of DL-LBT. For example, when DL-LBT yields the result of LBT_busy (DL transmission is limited), the user terminal can perform receiving processes for the PHICH and so on, assuming that the delivery acknowledgment signals to be transmitted from the radio base station are transmitted in a specific subframe.

<Method of Transmitting Multiple HARQ-ACKs>

Now, when delivery acknowledgment signals that are limited from being transmitted are transmitted in a specific subframe (for example, in the first subframe to be available for use), cases might occur where the radio base station multiplexes a plurality of delivery acknowledgment signals over one DL subframe/special subframe. For example, in FIG. 9, delivery acknowledgment signals corresponding to a plurality of UL subframes (U (2), U (3) of the half-radio frame (m)) are multiplexed over the PHICH in one DL subframe (D (0) in the half-radio frame (m+2)).

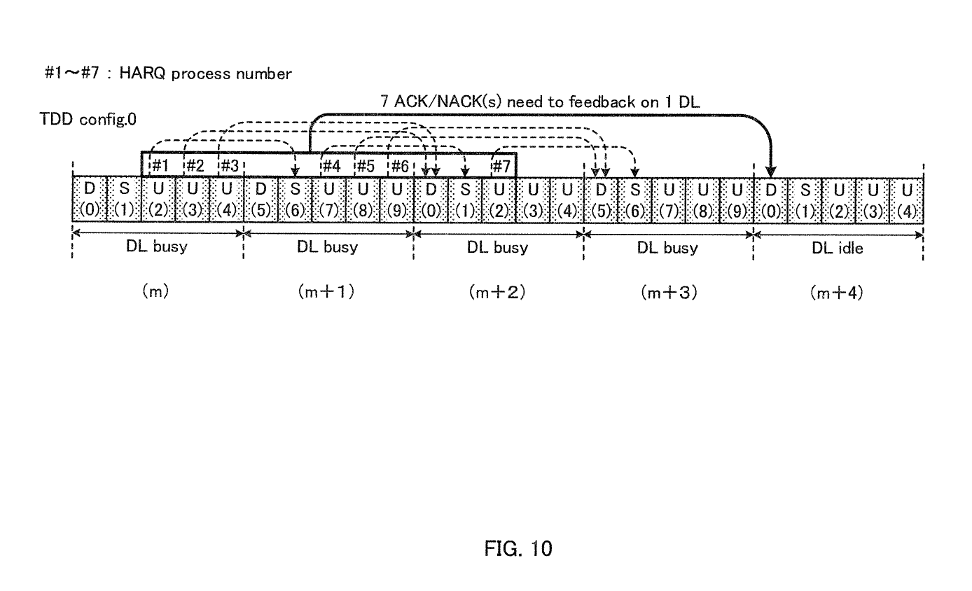

Considering the UL/DL configurations to use in TDD and the number of HARQ processes (see FIG. 4B), depending on the result of LBT, cases occur where delivery acknowledgment signals corresponding to maximum seven UL subframes are multiplexed over one DL subframe (FIG. 10). FIG. 10 shows examples of timings to transmit HARQ-ACKs in the event the periodicity of LBT is made 5 ms, in TDD in which UL/DL configuration 0 is employed. Also, FIG. 10 shows a case where DL transmission is limited (LBT_busy) in the half-radio frames (m) to (m+3), and DL transmission is not limited (LBT_idle) in the half-radio frame (m+4).

In this case, if HARQ-ACK transmission is controlled as shown in above FIG. 9, the radio base station has to multiplex delivery acknowledgment signals a plurality of UL subframes over the DL subframe (D (0)) of the half-radio frame (m+4). Note that the DL subframe (D (0)) of the half-radio frame (m+4) is equivalent to the first DL subframe, in which transmission becomes available after LBT_busy is yielded.

Assuming this case, the present inventors have come with a method of applying bundling to transmission (the first method), and a method of allocating a plurality of delivery acknowledgment signals separately (applying different PHICH resources) (the second method). Each method will be described below.

<Bundling>

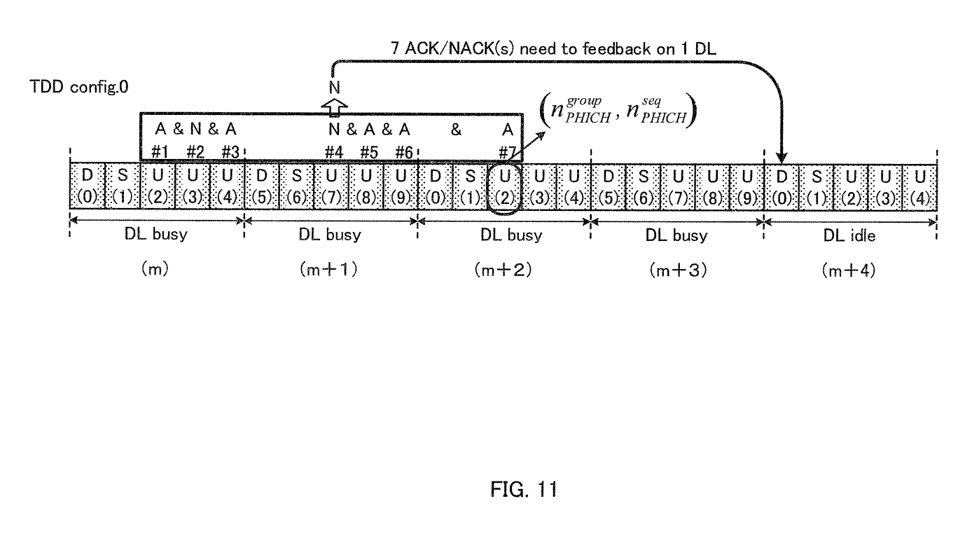

In the first method, the radio base station bundles a plurality of delivery acknowledgment signals, allocates this bundle to a DL subframe (PHICH) (see FIG. 11). For example, if any of a plurality of delivery acknowledgment signals (in FIG. 11, seven HARQ-ACKs) yields a NACK, the radio base station acknowledges a NACK over the PHICH of the DL subframe (0), and transmits this to the user terminal. On the other hand, if all of a plurality of delivery acknowledgment signals yield an ACK, the radio base station multiplexes an ACK over the PHICH of the DL subframe (0), and transmits this to the user terminal. In this way, by bundling delivery acknowledgment signal that are limited from being transmitted, it is possible to reduce the number of bits to allocate to the PHICH in a DL subframe (for example, down to one bit). Since the overhead of control channel resources to be shared between user terminals can be reduced, it then becomes possible to schedule or accommodate more user terminals in a subframe.

Also, in existing LTE/LTE-A, the PHICH resource to allocate a PUSCH delivery acknowledgment signal is determined based on a pair of a PHICH group index (n^{group}_{PHICH}) and an orthogonal sequence index (n^{seq}_{PHICH} (n^{group}_{PHICH}, n^{seq}_{PHICH}). The orthogonal sequence index is the orthogonal sequence in the PHICH group. Also, the PHICH group index and the orthogonal sequence index are determined by the resource block index where the PUSCH is allocated, the cyclic shift (SC) index of the DM-RS used for the PUSCH, and so on. Consequently, the PHICH resource to allocate a delivery acknowledgment signal of a PUSCH is determined based on the transmission condition of the PUSCH.

As shown in FIG. 11, when a plurality of delivery acknowledgment signals are bundled, how to determine to which PHICH resource the bundle should be allocated is the problem. So, with the present embodiment, transmission is controlled by using the PHICH resource that is allocated to the delivery acknowledgment signal in a specific UL subframe among a plurality of UL subframes.

For example, the PHICH resource to use in D (0) can be determined based on the subframe that is placed last in the time direction among a plurality of UL subframes that are bundled (in FIG. 11, U (2) of the half-radio frame (m+2)). That is, when there are a plurality of delivery acknowledgment signals that are limited from being transmitted, PHICH resources can be determined based on the PUSCH transmission condition of the UL subframe with the largest HARQ process number (in FIG. 11, HARQ process #7).

In this case, the user terminal applies retransmission control to delivery acknowledgment signals that are limited from being transmitted (bundle), based on one PHICH resource of the DL subframe (D (0)). In this way, even when a plurality of delivery acknowledgment signals are bundled, the user terminal can correctly identify the PHICH resources in which the radio base station transmits delivery acknowledgment signals, and apply HARQ adequately.

<When Multiple PHICH Resources are Used>

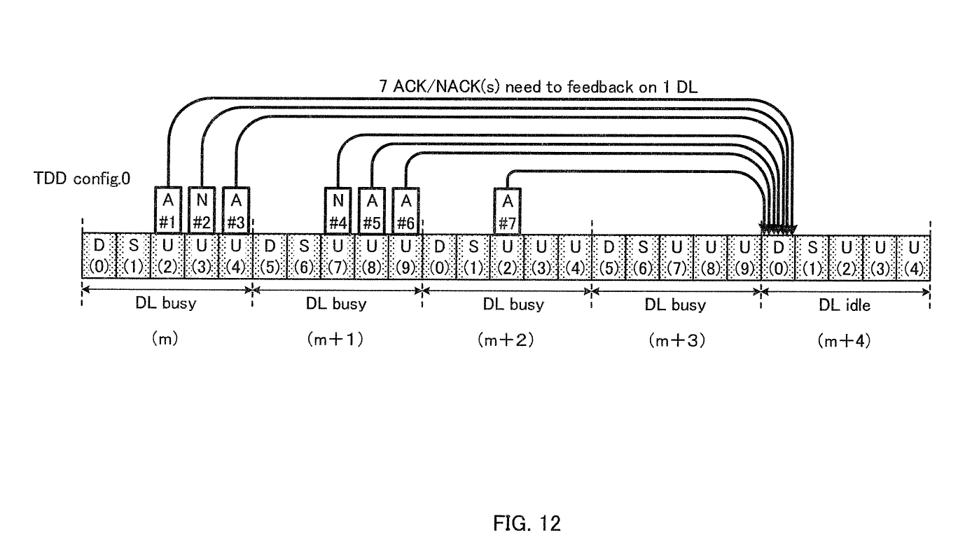

According to the second method, the radio base station transmits delivery acknowledgment signals by using a different PHICH resource for each of a plurality of UL subframes (delivery acknowledgment signals) that are limited from being transmitted (see FIG. 12). In this case, the radio base station can transmit each of the delivery acknowledgment signals that correspond to respective UL subframes in association with a predetermined PHICH resource (the PUSCH transmission condition in each UL subframe, etc.).

In this case, the user terminal can receive the delivery acknowledgment signal in each UL subframe based on multiple (maximum seven) PHICH resources that correspond to respective UL subframes. By this means, the user terminal can catch each delivery acknowledgment signal that is limited from being transmitted, and execute retransmission control accordingly.

### THIRD EXAMPLE

A case will be described with a third example where a new PHICH resource allocation method is employed when a plurality of delivery acknowledgment signals are multiplexed over multiple PHICH resources in one subframe (the second method/FIG. 12 of the second example).

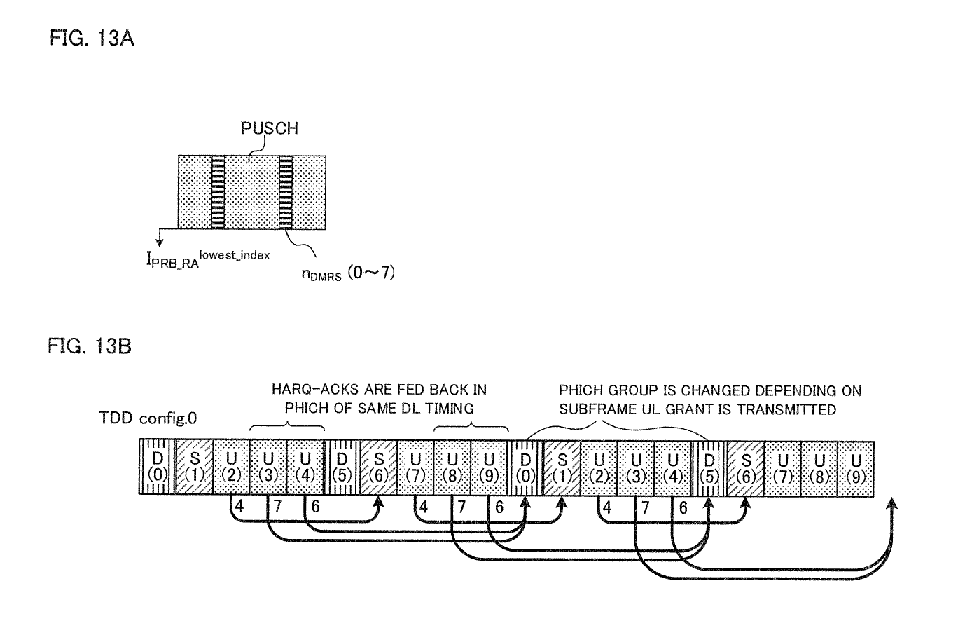

As mentioned earlier, in existing LTE/LTE-A, the PHICH resource to map a UL HARQ-ACK is determined based on a pair of a PHICH group index (n^{group}_{PHICH}) and an orthogonal sequence index (n^{seq}_{PHICH}) (n^{group}_{PHICH}, n^{seq}_{PHICH}). Also, the PHICH group index and the orthogonal sequence index are defined based on (1) the lowest resource block index where the PUSCH is allocated (lowest PRB index), (2) the cyclic shift index applied to the DM-RS used for the PUSCH (CS index), and (3) the UL subframe index in which the PUSCH is transmitted (see FIG. 13A). To be more specific, a pair of a PHICH group index and an orthogonal sequence index (PHICH resource) are determined based on following equations 1.

n_{PHICH}^{group}=(I_{PRB}_{_}_{RA}^{lowest}^{_}^{index}+n_{DMRS})mod N_{PHICH}^{group}+I_{PHICH}N_{PHICH}^{group}

n_{PHICH}^{seq}=(└I_{PRB}_{_}_{RA}^{lowest}^{_}^{index}/N_{PHICH}^{group}┘+n_{DMRS})mod 2N_{SF}^{PHICH} (Equations 1)

where:

I_{PRB}_{_}_{RA}^{lowest}^{_}^{index}: the minimum PRB index in PUSCH transmission;

n_{DMRS}: the cyclic shift index applied to the DM-RS used for the PUSCH;

N_{PHICH}^{group}: parameter related to the number of PHICH groups reported in higher layer;

I_{PHICH}: parameter used in PUSCH transmission in a specific UL subframe index in UL/DL configuration 0; and

N_{SF}^{PHICH}: the spreading factor size to use in PHICH modulation.

IPHICH Note that I_{PHICH} is a parameter to be “1” in PUSCH transmission in subframe 4 or 9 in UL/DL configuration 0, and to be “0” elsewhere.

In equations 1, (3) the UL subframe index in which the PUSCH is transmitted is taken into account only when UL/DL configuration 0 is used. This is because, in UL/DL configuration 0, delivery acknowledgment signals corresponding to two UL subframes (U (3) and U (4) or U (8) and U (9)) are transmitted in the same DL subframes (D (0), D (5)) (see FIG. 13B). That is, delivery acknowledgment signals for two UL subframes need to be allocated to the PHICH of the same DL subframe. Consequently, in a specific DL subframe in UL/DL configuration 0, PHICH resources are determined taking into account the UL subframe indices. To be more specific, by changing the PHICH group index by using I_{PHICH} in above equations 1, collisions of PHICHs are avoided.

So, as shown in above FIG. 12, it may be possible to use equations 1 when, based on LBT results, delivery acknowledgment signals for respective UL subframes are allocated to PHICH resources in one DL subframe/special subframe. However, in this case, there is a possibility that PHICH resources that are allocated to separate delivery acknowledgment signals collide with each other due to different PUSCH transmission conditions between UL subframes (including, for example, using the same PRB, and/or others).

Also, it may be possible to use I_{PHICH} (0 or 1) in equations 1 based on the index of each UL subframe. However, when LBT_busy is yielded across different radio frames, there is a possibility that the UL subframe indices where transmission is limited might overlap. In this case, PHICH resources allocated to separate delivery acknowledgment signals might collide with each other.

In this way, the method (equation) for determining PHICH resources taking into account the case where the transmission timings of delivery acknowledgment signals that are limited from being transmitted (PHICH subframe timings) are changed has not been proposed yet. Consequently, when above equations 1 are used, there is a possibility that the user terminal is unable to use the PHICH properly.

So, the present embodiment proposes a new method for determining PHICH resources for delivery acknowledgment signals, the transmission timings of which are delayed due to the result of LBT (LBT_busy). To be more specific, the PHICH resource to use for each UL subframe's delivery acknowledgment signal is explicitly reported to the user terminal. Alternatively, the PHICH resource to use for each UL subframe's delivery acknowledgment signal is implicitly selected.

<Explicit Indication of PHICH Resources>

In this case, the PHICH resources for delivery acknowledgment signals that correspond to each UL subframe are determined in advance and reported to the user terminal. For example, the radio base station (or the network) reports predetermined PHICH resources to the user terminal in advance, through higher layer signaling (for example, RRC signaling, etc.). The user terminal performs the receiving processes of delivery acknowledgment signals by using PHICH resource specified by higher layer signaling and so on.

Alternatively, the radio base station (or the network) may report predetermined PHICH resources to the user terminal by using L1/L2 control signals (for example, downlink control information (PDCCH)) and/or the like. In this case, the user terminal can receive delivery acknowledgment signals by using the PHICH resources that are specified by control signals included in UL grants and so on. Also, it is equally possible to combine higher layer signaling and downlink control information, and report PHICH resources to the user terminal. For example, the DL HARQ-ACK mechanism (ARI) in PUCCH3 of existing LTE-A systems can be used.

<Implicit Selection of PHICH Resources>

In this case, control is applied so that an offset is applied to the PHICH resource index for each delivery acknowledgment signal that is multiplexed over the PHICH of one DL subframe/special subframe. For example, based on the subframe indices and/or the UL HARQ process numbers to correspond to each delivery acknowledgment signal, offsets are applied to the PHICH resource indices.

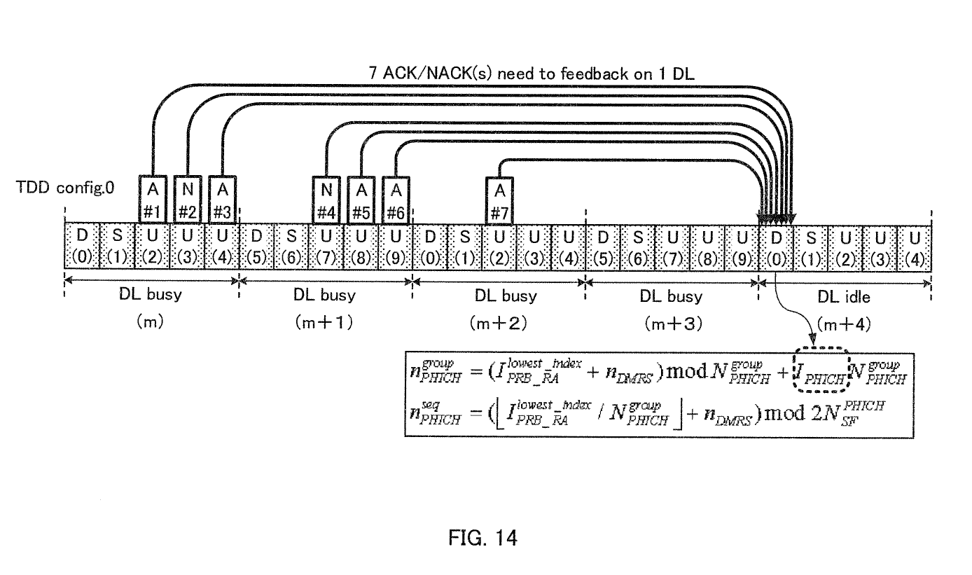

To be more specific, the value of I_{PHICH} in above equations 1 is changed based on the UL subframe indices and/or the HARQ process numbers to be processed at the same time (see FIG. 14). By this means, as for PHICH group indices, offsets may be applied per multiple of the number of PHICH groups (N^{group}_{PHICH}). Note that the change of I_{PHICH} can be determined based on the subframe index and/or the UL HARQ process number corresponding to each delivery acknowledgment signal. In this case, the maximum number of I_{PHICHs} can be made equal to or less than the number of HARQ process numbers.

In particular, since the value of I_{PHICH} is changed based on HARQ process numbers, it is possible to reduce the collisions of PHICH resources effectively even when the UL subframe indices where transmission is limited overlap. Note that, when the value of I_{PHICH} is changed based on subframe indices, subframes to show the same subframe index (that is, have the same value of x in U (x)) on the radio base station end may be controlled not to assign the same resource block (PRB) index and/or cyclic shift index (CS index) to user terminals.

In this way, by changing the value of I_{PHICH} based on UL subframe indices and/or HARQ process numbers, it is possible to apply offset between UL HARQ-ACKs for a plurality of PUSCHs allocated to a user terminal. By this means. it is possible to prevent collisions of PHICH resources even when a plurality of UL HARQ-ACKs are multiplexed over one subframe. Note that the value to change based on UL subframe indices and/or HARQ process numbers is not limited to I_{PHICH}, and it is equally possible to change other parameters in equations 1 or apply new offsets.

### FOURTH EXAMPLE

Although a method for selecting PHICH resources implicitly has been described above with the third example, now, a method that is different from that of the above third example will be described with a fourth example.

A case has been shown with the above third example where a plurality of delivery acknowledgment signals to multiplex in one DL subframe are allocated to different PHICH resources by applying offsets based on UL subframe indices and/or HARQ process numbers.

In this case, a plurality of delivery acknowledgment signals to multiplex over a PHICH can be effectively prevented from colliding with each other. Meanwhile, more PHICH resources need to be used. For example, maximum seven times more PHICH resources are required, compared to the case of using FDD in a licensed band. When more PHICH resources are used, it might become difficult to transmit PHICHs to other user terminals. Also, the radio resources that can be used for the PDCCH and so on might decrease. So, the fourth example proposes a method for reducing the overhead of PHICH resources.

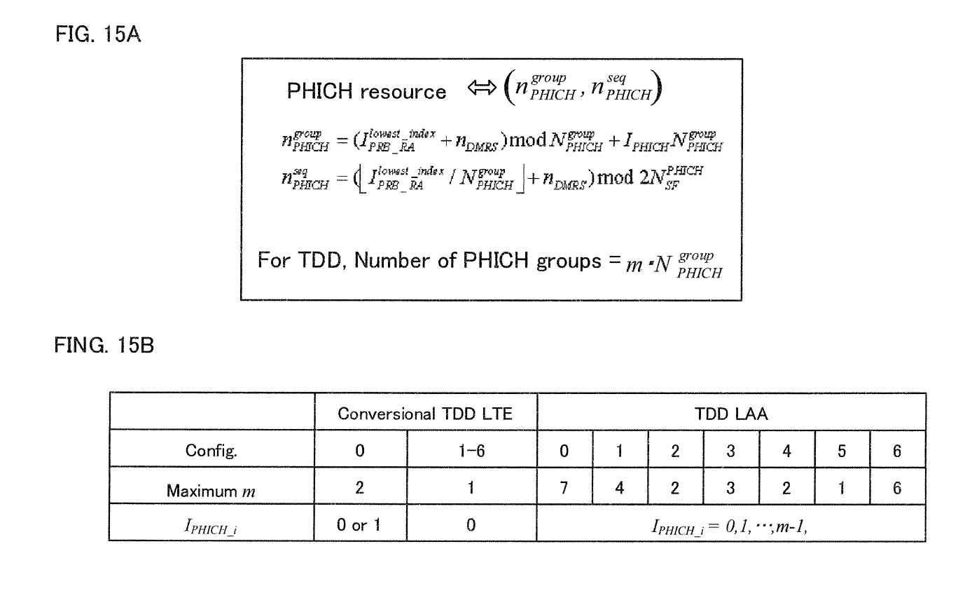

As mentioned earlier, a PHICH resource can be determined from the combination of the PHICH group index and the orthogonal sequence index used in this group (see FIG. 15A). Also, the PHICH group index and the orthogonal sequence index depend upon the number of PHICH groups (see above equations 1). The number of PHICH groups is fixed in all subframes when FDD is used, and is represented by N^{group}_{PHICH} that is configured by higher layer signaling. By contrast, when TDD is used, the number of PHICH groups may vary per DL subframe/special subframe, and is represented as (m·N^{group}_{PHICH}) by using N_{group}^{PHICH} and m, which are configured by higher layer signaling (see FIG. 15A).

In existing LTE/LTE-A, the maximum number of m's is configured to be two in TDD UL/DL configuration 0, and the maximum number of m's is configured to be one in the other UL/DL configurations 1 to 6. Also, as described above, in existing LTE/LTE-A, I_{PHICH}, which is used to determine PHICH group indices, is configured to be 0 or 1 in UL/DL configuration 0, and I_{PHICH} is configured to be 0 in the other UL/DL configurations 1 to 6.

Meanwhile, as has been shown with the above third embodiment (FIG. 14), when the timing to transmit a delivery acknowledgment signal is controlled based on the result of LBT, the maximum value of m can be configured based on the number of HARQ processes. Also, as described above, in order to apply an offset to each delivery acknowledgment signal's PHICH resource, I_{PHICH} can be determined based on the value of this m (see FIG. 15B). However, when I_{PHICH} is configured according to the number of HARQ process numbers, there is a threat that the number of PHICH groups increases and the overhead of PHICH resources also increases.

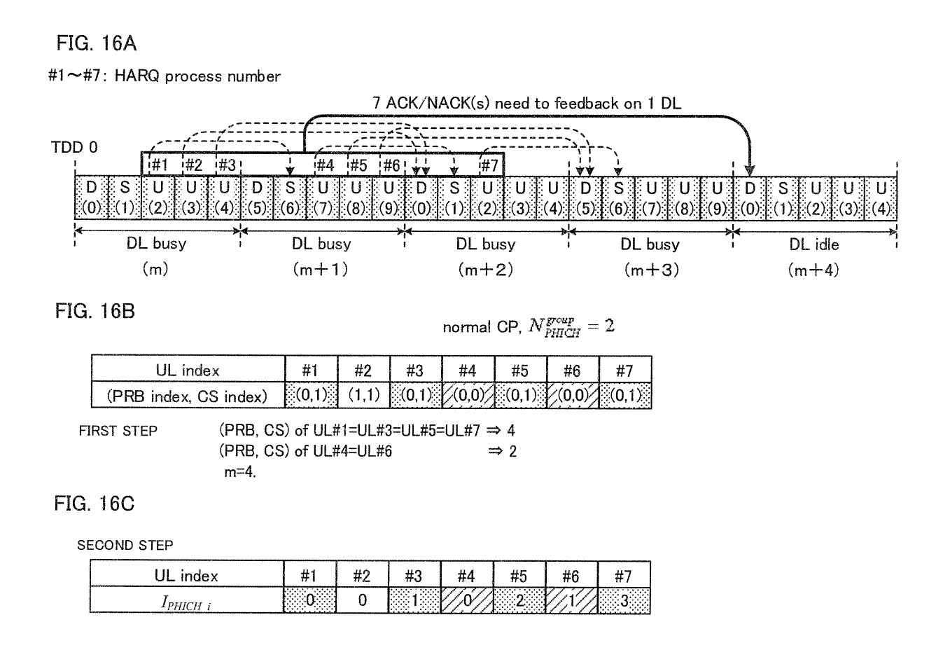

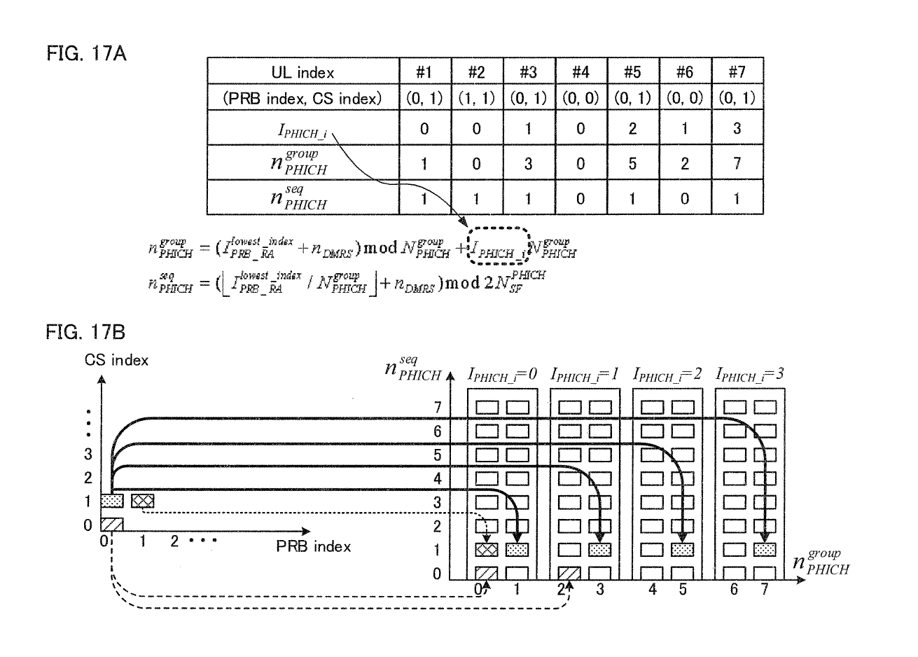

So, according to the fourth example, I_{PHICH} is configured based on the number of UL subframes (HARQ processes) in which the PRB index and the cyclic shift (CS) index applied to the PUSCH are the same. For example, I_{PHICH} is at least configured differently between HARQ processes (delivery acknowledgment signals) in which the PRB index and the CS index of PUSCH are the same. Also, it is possible to allow configuring the same I_{PHICH} in HARQ processes (delivery acknowledgment signals) with different PRB indices or CS indices. Now, this will be described below with reference to FIG. 16 and FIG. 17.

FIG. 16A shows examples of HARQ-ACK timings where the periodicity of LBT is made 5 ms, in TDD in which UL/DL configuration 0 is employed. Also, FIG. 16A shows a case where DL transmission is limited (LBT_busy) in half-radio frames (m) to (m+3), and DL transmission is not limited (LBT_idle) in half-radio frame (m+4).

Also, a case is assumed here where the normal CP (Cyclic Prefix) and N^{group}_{PHICH}, which is configured by higher layer signaling, are two. Furthermore, a case is assumed here where the PRB indices and CS indices shown in FIG. 16B are assigned to the PUSCH transmitted in each UL subframe (HARQ processes #1 to #7). The method of determining PHICH resources in this case will be described below.

<First Step>

First, the radio base station determines the value of “m,” which is configured to the maximum value of I_{PHICH} based on the PRB index and the CS index of the PUSCH that is transmitted in each UL subframe (HARQ process number). To be more specific, the value of “m” is determined based on delivery acknowledgment signals (the number of HARQ processes) with the same PRB index and CS index applied to the corresponding PUSCHs. In FIG. 16B, the same PRB index and CS index are applied to the four UL subframes of HARQ process numbers (UL indices) UL #1=UL #3=UL #5=UL #7. Also, the same PRB index and CS index are applied to the two UL subframes of UL #4=UL #6.

Consequently, among the seven UL subframes, the maximum number of UL subframes to use the same PRB index and CS index is four, rendering the decision m=4.

<Second Step>

Next, I_{PHICH} for each UL subframe (HARQ process number) is determined based on m determined in the first step. For example, I_{PHICH} is configured differently between UL subframes in which the PRB index and CS index are the same. Also, a number of I_{PHICHs}, provided in ascending order from 0, may be configured in UL subframes with the same PRB index and CS index, following the order of HARQ process numbers (see FIG. 16C).

Here, 0, 1, 2 and 3 are configured as I_{PHICH} in UL #1, UL #3, UL #5 and UL #7, respectively. Similarly, 0 and 1 are configured as I_{PHICH} in UL #4 and UL #6, respectively. Also, I_{PHICH} in UL #2 is configured to 0. That is, I_{PHICH} is at least configured differently between HARQ process numbers with the same PRB index and CS index, and I_{PHICH} is allowed to be configured the same between HARQ process numbers with varying PRB indices or CS indices. By this means, the number of I_{PHICHs} to configure can be reduced.

After I_{PHICH} to configure in each UL subframe (HARQ process number) is determined in the second step, the PHICH group indices and orthogonal sequence indices (PHICH resources) are determined based on above-noted equations 1 (see FIG. 17A). The radio base station allocates delivery acknowledgment signals, corresponding to respective HARQ process numbers, to predetermined PHICH resources, based on the PHICH group indices and orthogonal sequence indices that are calculated (see FIG. 17B).

FIG. 17B show an example of a method of allocating delivery acknowledgment signals corresponding to seven UL subframes (HARQ process numbers). By employing the present embodiment, as shown in FIG. 17B, it is possible to make the number of I_{PHICHs} the maximum number of UL subframes where the PRB index and CS index are the same (here, four). By this means, it is possible to reduce the PHICH resources to use in the same subframe.

(Structure of Radio Communication System)

Now, the structure of the radio communication system according to the present embodiment will be described below. In this radio communication system, the above-described radio communication methods of the first example to the fourth example are employed. Note that the above-described radio communication methods of the first example to the fourth example may be applied individually or may be applied in combination.

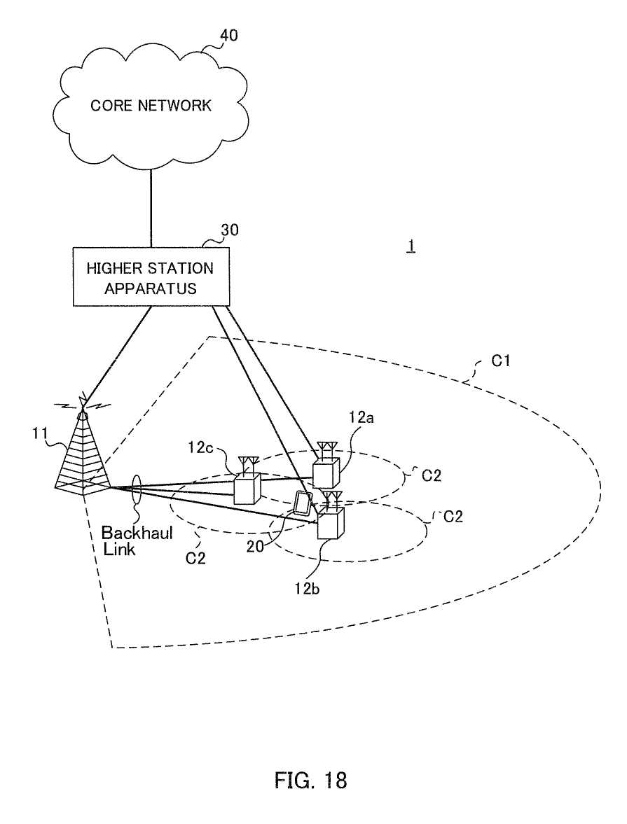

FIG. 18 is a diagram to show a schematic structure of the radio communication system according to the present embodiment. Note that the radio communication system shown in FIG. 18 is, for example, an LTE system, or a system to incorporate SUPER 3G. This radio communication system can adopt carrier aggregation (CA) to group a plurality of fundamental frequency blocks (component carriers) into one, where the LTE system bandwidth constitutes one unit, and/or adopt dual connectivity (DC). Also, the radio communication system shown in FIG. 18 has a licensed band and an unlicensed band (LTE-U base station). Note that this radio communication system may be referred to as “IMT-advanced,” or may be referred to as “4G,” “5G,” “FRA” (Future Radio Access), etc.

The radio communication system 1 shown in FIG. 18 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed band and at least one of the small cells C2 is used in an unlicensed band (LTE-U). Also, a structure to use part of the small cells C2 in a licensed band and use the other small cells C2 in an unlicensed band may be possible.

The user terminals 20 can connect with both the radio base station 11 and the radio base stations 12. The user terminals 20 can use the macro cell C1 and the small cells C2, which use different frequencies, at the same time, by means of CA or DC. In this case, it is possible to transmit information (assist information) about a radio base station 12 that uses an unlicensed band, from the radio base station 11 that uses a licensed band to the user terminals 20. Also, a structure may also be employed in which, when CA is executed between a licensed band and an unlicensed band, one radio base station (for example, the radio base station 11) controls the scheduling of the licensed band cells and the unlicensed band cells.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used in the radio base station 11 may be used. Between the radio base station 11 and the radio base stations 12 (or between the radio base stations 12), wire connection (optical fiber, the X2 interface and so on) or wireless connection can be established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as an “eNodeB,” a “macro base station,” a “transmitting/receiving point,” and so on. Also, the radio base stations 12 are radio base stations having local coverages, and may be referred to as “small base stations,” “pico base stations,” “femto base stations,” “Home eNodeBs,” “RRHs” (Remote Radio Heads), “micro base stations,” “transmitting/receiving points,” and so on. Hereinafter the radio base stations 11 and 12 will be collectively referred to as “radio base stations 10,” unless specified otherwise. The user terminals 20 are terminals to support various communication schemes such as LTE, LTE-A and so on, and may be either mobile communication terminals or stationary communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands.

Now, communication channels used in the radio communication system shown in FIG. 18 will be described. Downlink communication channels include a PDSCH (Physical Downlink Shared CHannel), which is used by each user terminal 20 on a shared basis, and downlink L1/L2 control channels (PCFICH, PHICH, PDCCH and enhanced PDCCH). User data and higher control information are communicated by the PDSCH. Scheduling information for the PDSCH and the PUSCH and so on are communicated by the PDCCH (Physical Downlink Control CHannel). The number of OFDM symbols to use for the PDCCH is communicated by the PCFICH (Physical Control Format Indicator CHannel). Delivery acknowledgement signals (also referred to as “HARQ ACKs” or “ACKs/NACKs”) in response to the PUSCH are communicated by the PHICH (Physical Hybrid-ARQ Indicator CHannel). Also, the scheduling information for the PDSCH and the PUSCH and so on may he communicated by the enhanced PDCCH (EPDCCH) as well. This EPDCCH is frequency-division-multiplexed with the PDSCH (downlink shared data channel).

Uplink communication channels include a PUSCH (Physical Uplink Shared CHannel), which is used by each user terminal 20 on a shared basis as an uplink data channel, and a PUCCH (Physical Uplink Control CHannel), which is an uplink control channel. User data and higher control information are communicated by this PUSCH. Also, by the PUCCH, downlink channel state information (CSI), delivery acknowledgment signals (also referred to as “HARQ-ACKs,” “A/Ns,” or “ACKs/NACKs”), scheduling requests (SRs) and so on are communicated. Note that the channel state information includes radio quality information (CQI), precoding matrix indicators (PMIs), rank indicators (RIs) and so on.

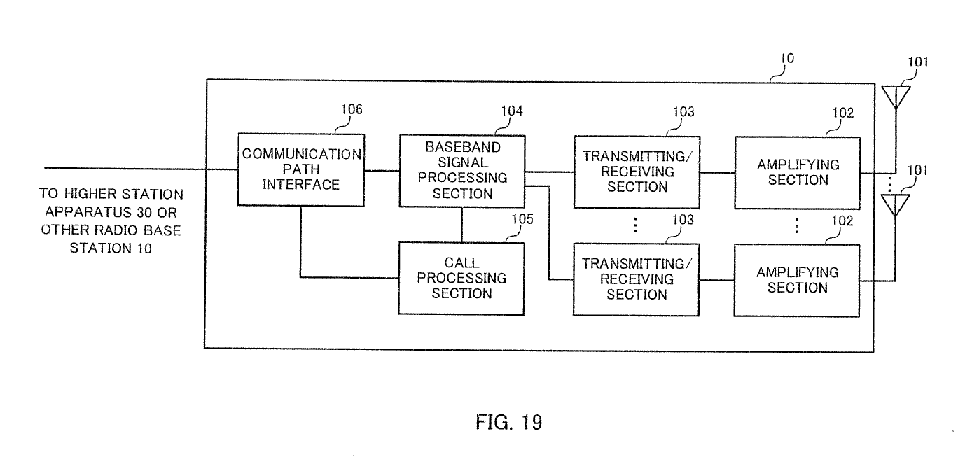

FIG. 19 is a diagram to show an overall structure of a radio base station 10 (which may be either a radio base station 11 or 12) according to the present embodiment. The radio base station 10 has a plurality of transmitting/receiving antennas 101 for MIMO communication, amplifying sections 102, transmitting/receiving sections 103 (transmitting sections/receiving sections), a baseband signal processing section 104, a call processing section 105 and a communication path interface 106.

User data (DL data) to be transmitted from the radio base station 10 to a user terminal 20 on the downlink is input from the higher station apparatus 30 to the baseband signal processing section 104, via the communication path interface 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control channel signals are also subjected to transmission processes such as channel coding and an inverse fast Fourier transform, and forwarded to each transmitting/receiving section 103.

Also, the baseband signal processing section 104 reports, to the user terminal 20, control information for allowing communication in the cell (system information), through higher layer signaling (for example, RRC signaling, broadcast information and so on). The information for allowing communication in the cell includes, for example, the uplink or downlink system bandwidth and so on.

Also, it is possible to transmit information about LBT (for example, part or all of the LBT subframes, the LBT symbols and the periodicity of LBT) from the transmitting/receiving sections 103 of the radio base station 10 to the user terminal. Also, it is equally possible to transmit, explicitly, information about the PHICH resources for allocating a plurality of delivery acknowledgment signals that are multiplexed in a predetermined subframe, from the transmitting/receiving sections 103 of the radio base station 10 to the user terminal, through higher layer signaling. For example, the radio base station 10 reports these pieces of information to the user terminal via a licensed band and/or an unlicensed band. Also, the radio base station 10 may transmit a DL-BRS based on the result of LBT (for example, when LBT_idle is yielded) (see FIG. 8).

Each transmitting/receiving section 103 converts the baseband signals, which are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101. Note that the transmitting/receiving sections (transmission sections/receiving sections) 103 can be formed with transmitters/receivers, transmitting/receiving circuits (transmitting circuits/receiving circuits) or transmitting/receiving devices (transmitting devices/receiving devices) that are used in the technical field to which the present invention pertains.

Meanwhile, as for data to be transmitted from the user terminal 20 to the radio base station 10 on the uplink, radio frequency signals that are received in the transmitting/receiving antennas 101 are each amplified in the amplifying sections 102, converted into the baseband signal through frequency conversion in each transmitting/receiving section 103, and input in the baseband signal processing section 104.

In the baseband signal processing section 104, the user data that is included in the input baseband signal is subjected to an FFT process, an IDFT process, error correction decoding, a MAC retransmission control receiving process, and RLC layer and PDCP layer receiving processes, and the result is forwarded to the higher station apparatus 30 via the communication path interface 106. The call processing section 105 performs call processing such as setting up and releasing communication channels, manages the state of the radio base stations 10 and manages the radio resources.

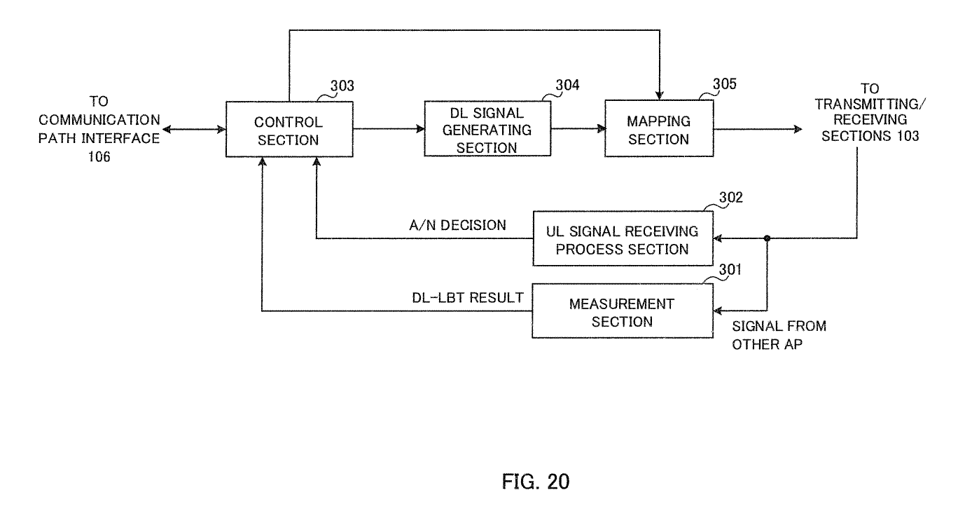

FIG. 20 is a diagram to show a principle functional structure of the baseband signal processing section 104 provided in the radio base station 10 according to the present embodiment. Note that, although FIG. 20 primarily shows functional blocks that pertain to characteristic parts of the present embodiment, the radio base station 10 has other functional blocks that are necessary for radio communication as well.

As shown in FIG. 20, the radio base station 10 has a measurement section 301, UL signal receiving process section 302, a control section (scheduler) 303, a DL signal generating section 304, and a mapping section (allocation control section) 305.

The measurement section 301 listens to (detects/measures) signals transmitted from other transmission points (APs/TPs) in an unlicensed band. To be more specific, the measurement section 301 detects/measures signals from other transmission points at predetermined timings such as before transmitting DL signals, and outputs the detection/measurement results (LBT results) to the control section 303. For example, if a signal is detected, the measurement section 301 decides whether or not its power level is equal to or higher than a predetermined threshold, and reports the decision (LBT result) to the control section 303. Note that the measurement section 301 can be measurer or a measurement circuit used in the technical field to which the present invention pertains.

The UL signal receiving process section 302 performs receiving processes (for example, the decoding process, the demodulation process and so on) for the UL signals (PUCCH signals, PUSCH signals and so on) transmitted from the user terminals. Also, the UL signal receiving process section 302 can apply retransmission control (UL hybrid ARQ) to the PUSCHs transmitted from the user terminals. In this case, the UL signal receiving process section 302 decides on an ACK when the PUSCH transmitted from a user terminal is received properly, or decides on a NACK when the PUSCH transmitted from a user terminal is not received properly (failure of receipt), and outputs the decision to the control section 303. Note that a structure may be employed here in which a decision section to make decisions for retransmission control (UL hybrid ARQ) for the PUSCH is provided apart from the UL signal receiving process section 302. Note that UL signal receiving process section 302 can be formed with a signal processor or a signal processing circuit that is used in the technical field to which the present invention pertains.

The control section (scheduler) 303 controls the allocation (transmission timings) of downlink data signals that are transmitted in the PDSCH, and downlink control signals (UL grant/DL assignment) that are communicated in the PDCCH and/or the enhanced PDCCH (EPDCCH). Also, the control section 303 controls the allocation (transmission timings) of the PHICH and the PCFICH, which are L1/L2 control signals besides the PDCCH. Also, the control section 303 controls the allocation (transmission timing) of system information (PBCH), synchronization signals (PSS/SSS) and downlink reference signals (CRS, CSI-RS and so on). Note that the control section 303 can be formed with a controller, a scheduler, a control circuit or a control device that is used in the technical field to which the present invention pertains.

The control section 303 controls the transmissions of DL signals in an LBT-configured carrier (for example, an unlicensed band) based on the results of LBT output from the measurement section 301. For example, the control section 303 controls the allocation of delivery acknowledgment signals to the PHICH based on the decisions of retransmission control for the PUSCH transmitted from the user terminal.

To be more specific, the control section 303 controls the transmission of delivery acknowledgment signals based on the result of DL-LBT. When transmission is not limited due to the result of LBT result, the control section 303 controls the transmission of delivery acknowledgment signals at predetermined transmission timings (see, for example, FIG. 4B). Also, when the delivery acknowledgment signal in subframe i is limited from being transmitted due to the result of LBT, this delivery acknowledgment signal that is limited from being transmitted is controlled to be transmitted in a predetermined subframe, in which a delivery acknowledgment signal can be transmitted, after subframe i.

For this predetermined subframe, a subframe that is delayed in radio frame units from subframe i can be used (see FIG. 6 and FIG. 7). Alternatively, the control section 303 can control a plurality of delivery acknowledgment signals that are limited from being transmitted based on LBT results, to be transmitted in predetermined subframe (see FIG. 9). In this case, the first subframe after subframe i that can transmit a delivery acknowledgment signal can be used for the predetermined subframe.

Also, when a plurality of delivery acknowledgment signals are multiplexed over a predetermined subframe, the control section 303 can control these multiple delivery acknowledgment signals to be transmitted in a bundle (see FIG. 11). In this case, it is possible to control the result of bundling to be transmitted by using the PHICH resource that is allocated to the delivery acknowledgment signal that is transmitted in the last subframe in the bundle of multiple delivery acknowledgment signals.

Also, when a plurality of delivery acknowledgment signals are multiplexed over a predetermined subframe (see FIG. 12), the control section 303 can determine the PHICH resource for each of the multiple delivery acknowledgment signals based on the subframe index and/or the HARQ process number that correspond to each delivery acknowledgment signal (see FIG. 14). Alternatively, the control section 303 can control the allocation of PHICH resources by applying different offsets to delivery acknowledgment signals, between which the same PRB index and cyclic shift index are used for uplink data, among a plurality of delivery acknowledgment signals (see FIG. 16 and FIG. 17).

The DL signal generating section 304 generates DL signals based on commands from the control section 303. The DL signals may include DL control signals (PDCCH signal, EPDCCH signal, PHICH signal, etc.), downlink data signals (PDSCH signal), downlink reference signals (CRS, CSI-RS, DM-RS, etc.) and so on. Also, the DL signal generating section 304 may generate DL-BRSs when DL-LBT yields the result of LBT_idle (see FIG. 8). Note that the DL signal generating section 304 can be formed with a signal generator or a signal generating circuit that is used in the technical field to which the present invention pertains.

Also, the mapping section (allocation control section) 305 controls the mapping (allocation) of DL signals based on commands from the control section 303. To be more specific, when an LBT result output from the measurement section 301 renders a decision that a DL signal (for example, a delivery acknowledgement signal) can be transmitted, the mapping section 305 allocates the DL signal. Note that the mapping section 305 can be formed with a mapping circuit or a mapper that is used in the technical field to which the present invention pertains.

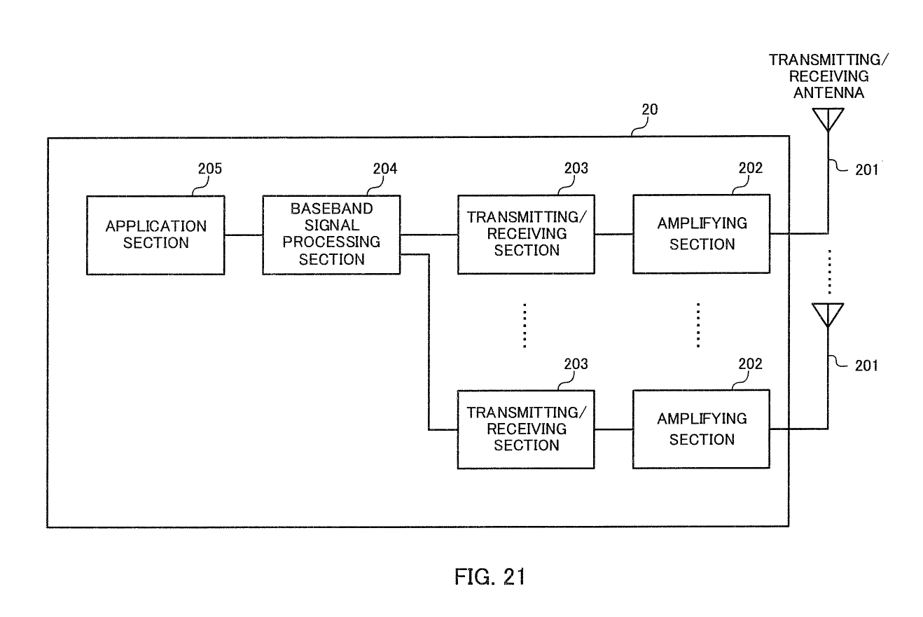

FIG. 21 is a diagram to show an overall structure of a user terminal 20 according to the present embodiment. The user terminal 20 has a plurality of transmitting/receiving antennas 201 for MIMO communication, amplifying sections 202, transmitting/receiving sections (transmitting sections and receiving sections) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to receiving processes such as an FFT process, error correction decoding and retransmission control (HARQ-ACK) in the baseband signal processing section 204. In this downlink data, downlink user data is forwarded to the application section 205. The application section 205 performs processes related to higher layers above the physical layer and the MAC layer. Furthermore, in the downlink data, broadcast information is also forwarded to the application section 205.

Meanwhile, uplink user data is input from the application section 205 to the baseband signal processing section 204. In the baseband signal processing section 204, a retransmission control (HARQ: Hybrid ARQ) transmission process, channel coding, precoding, a DFT process, an IFFT process and so on are performed, and the result is forwarded to each transmitting/receiving section 203.

The baseband signal that is output from the baseband signal processing section 204 is converted into a radio frequency band in the transmitting/receiving sections 203. After that, the amplifying sections 202 amplify the radio frequency signals having been subjected to frequency conversion, and transmit the resulting signals from the transmitting/receiving antennas 201. Also, the transmitting/receiving sections 203 can also receive information related to DL-LBT results (for example, DL-BRSs) transmitted form the radio base station. Note that the transmitting/receiving sections (transmission sections/receiving sections) 203 can be formed with transmitters/receivers, transmitting/receiving circuits (transmitting circuits/receiving circuits) or transmitting/receiving devices (transmitting devices/receiving devices) that are used in the technical field to which the present invention pertains.

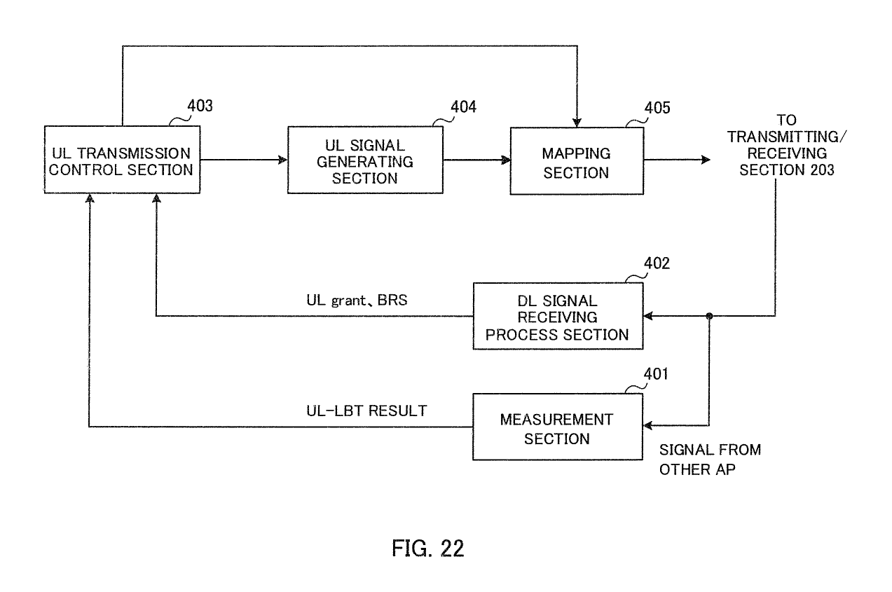

FIG. 22 is a diagram to show a principle functional structure of the baseband signal processing section 204 provided in the user terminal 20. Note that, although FIG. 22 primarily shows functional blocks that pertain to characteristic parts of the present embodiment, the user terminal 20 has other functional blocks that are necessary for radio communication as well.

As shown in FIG. 22, the user terminal 20 has a measurement section 401, a DL signal receiving process section 402, a UL transmission control section 403 (control section), a UL signal generating section 404 and a mapping section 405. Note that, when LBT in UL commination is performed on the radio base station end, the measurement section 401 can be removed.

The measurement section 401 detects/measures (LBT) signals transmitted from other transmission points (APs/TPs) in UL. To be more specific, the measurement section 401 detects/measures signals from other transmission points at predetermined timings such as before transmitting UL signals, and outputs the detection/measurement results (LBT results) to the UL transmission control section 403. For example, the measurement section 401 decides whether the power level of a detected signal is equal to or higher than a predetermined threshold, and reports the decision (LBT result) to the UL transmission control section 403. Note that the measurement section 401 can be a measurer or a measurement circuit used in the technical field to which the present invention pertains.

The DL signal receiving process section 402 performs receiving processes (for example, the decoding process, the demodulation process and so on) for the DL signals transmitted in the licensed band or the unlicensed band. For example, the DL signal receiving process section 402 acquires a UL grant that is included in downlink control signals (for example, DCI formats 0 and 4) and outputs this to the UL transmission control section 403. Also, when information about a DL-LBT result (for example, a DL-BRS) is transmitted from the radio base station, the DL signal receiving process section 402 can perform receiving operations by learning the DL-LBT result based on the DL-BRS.

Also, when a delivery acknowledgment signal in response to a PUSCH (PHICH) is received, the DL signal receiving process section 402 outputs this to the UL transmission control section 403. Note that the DL signal receiving process section 402 can be formed with a signal processor or a signal processing circuit that is used in the technical field to which the present invention pertains.

The UL transmission control section 403 controls the transmission of UL signals (UL data signals, UL control signals, reference signals and so on) to the radio base station in the licensed band and the unlicensed band. Also, the UL transmission control section 403 controls the transmission in the unlicensed band based on the detection/measurement results (LBT results) from the measurement section 401. That is, by taking into consideration the UL transmission commands (UL grants) transmitted from the radio base station and the detection results (LBT results) from the measurement section 401, the UL transmission control section 403 controls the transmission of UL signals in the unlicensed band.

Also, the UL transmission control section 403 controls the transmission of UL signals based on the receiving process results from the DL signal receiving process section 402. For example, when a UL HARQ-ACK that is allocated to a PHICH is an ACK, the UL transmission control section 403 judges that a PUSCH has been received properly in the radio base station. On the other hand, when the UL HARQ-ACK that is allocated to the PHICH is a NACK, the UL transmission control section 403 judges that the PUSCH has not been properly received in the radio base station, and control the PUSCH to be transmitted again.

The UL signal generating section 404 generates UL signals based on commands from the UL transmission control section 403. The UL signals may include UL control signals (PUCCH signal, PRACH signal, etc.), UL data signals (PUSCH signal), reference signals (SRS, DM-RS, etc.) and so on. Note that the UL signal generating section 404 can be formed with a signal generator or a signal generating circuit that is used in the technical field to which the present invention pertains.

The mapping section (allocation control section) 405 controls the mapping (allocation) of UL signals based on commands from the UL transmission control section 403. To be more specific, when an LBT result output from the measurement section 401 renders a decision that a UL signal can be transmitted, the mapping section 405 allocates a UL signal. Note that the mapping section 405 can be formed with a mapping circuit or a mapper that is used in the technical field to which the present invention pertains.

As described above, according to the present embodiment, UL HARQ-ACK feedback is controlled based on the result of DL-LBT. By this means, the radio base station can adequately transmit HARQ-ACKs to user terminals regardless of the result of DL-LBT, so that it is possible to reduce the deterioration of communication quality.

Note that, although a case has been described above in which an unlicensed band cell controls whether or not DL signals can be transmitted based on the result of LBT, the present embodiment is by no means limited to this. For example, the present embodiment is equally applicable to cases where, depending on the result of LBT, transitions are made to other carriers by DFS (Dynamic Frequency Selection), transmission power control (TPC) is applied, and so on.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of claims. For example, a plurality of examples described above may be combined and implemented as appropriate. Consequently, the description herein is only provided for the purpose of illustrating examples, and should by no means be construed to limit the present invention in any way.

The disclosure of Japanese Patent Application No. 2014-226330, filed on Nov. 6, 2014, including the specification, drawings and abstract, is incorporated herein by reference in its entirety.

1. A radio base station comprising:
a transmission section that transmits delivery acknowledgment signals in response to UL data that is transmitted from a user terminal; and
a control section that controls transmission of the delivery acknowledgment signals based on results of listening in downlink,
wherein, when transmission of a delivery acknowledgment signal is not limited based on a result of listening, the control section controls the transmission of the delivery acknowledgment signal at a predetermined transmission timing, and, when transmission of a delivery acknowledgment signal in a subframe i is limited based on a result of listening, controls the delivery acknowledgment signal that is limited from being transmitted to be transmitted in a predetermined subframe in which, after the subframe i, a delivery acknowledgment signal can be transmitted.

2. The radio base station according to claim 1, wherein the predetermined subframe is a subframe that is delayed by a radio frame unit from the subframe i.

3. The radio base station according to claim 1, wherein the control section controls a plurality of delivery acknowledgment signals that are limited from being transmitted based on results of listening, to be transmitted in the predetermined subframe.

4. The radio base station according to claim 3, wherein the predetermined subframe is a first subframe in which a delivery acknowledgment signal can be transmitted, after the subframe i.

5. The radio base station according to claim 3, wherein the control section transmits the plurality of delivery acknowledgment signals in a bundle in the predetermined subframe.

6. The radio base station according to claim 5, wherein, by using a Physical Hybrid-ARQ Indicator Channel (PHICH) resource that is allocated to a delivery acknowledgment signal that is transmitted in a last subframe in the bundle of the plurality of delivery acknowledgment signals, the control section controls the transmission of the bundle of the delivery acknowledgment signals.

7. The radio base station according to claim 3, wherein the control section determines a Physical Hybrid-ARQ Indicator Channel (PHICH) resource for each delivery acknowledgment signal based on a subframe index and/or a Hybrid Automatic Repeat reQuest (HARQ) process number corresponding to the delivery acknowledgment signal.

8. The radio base station according to claim 3, wherein the control section controls allocation of Physical Hybrid-ARQ Indicator Channel (PHICH) resources by applying different offsets to delivery acknowledgment signals, between which the same Physical Resource Block (PRB) index and cyclic shift index are used for uplink data, among the plurality of delivery acknowledgment signals.

9. A user terminal comprising:
a receiving section that receives a delivery acknowledgment signals that are transmitted from a radio base station; and
a control section that applies retransmission control to UL data based on the delivery acknowledgment signals received,
wherein, when transmission of a delivery acknowledgment signal is not limited based on a result of listening, the receiving section receives the delivery acknowledgment signal at a predetermined transmission timing, and, when transmission of a delivery acknowledgment signal in a subframe i is limited based on a result of listening, receives the delivery acknowledgment signal that is limited from being transmitted in a predetermined subframe in which, after the subframe i, a delivery acknowledgment signal can be transmitted.

10. A radio communication method for a radio base station that controls downlink transmission based on results of listening in downlink, the radio communication method comprising the steps of:
generating delivery acknowledgment signals in response to UL data that is transmitted from a user terminal; and
controlling transmission of the delivery acknowledgment signals based on results of listening,
wherein, when transmission of a delivery acknowledgment signal is not limited based on a result of listening, the transmission of the delivery acknowledgment signal is controlled at a predetermined transmission timing, and, when transmission of a delivery acknowledgment signal in a subframe i is limited based on a result of listening, the delivery acknowledgment signal that is limited from being transmitted is controlled to be transmitted in a predetermined subframe in which, after the subframe i, a delivery acknowledgment signal can be transmitted.

11. The radio base station according to claim 4, wherein the control section transmits the plurality of delivery acknowledgment signals in a bundle in the predetermined subframe.

12. The radio base station according to claim 4, wherein the control section determines a Physical Hybrid-ARQ Indicator Channel (PHICH) resource for each delivery acknowledgment signal based on a subframe index and/or a Hybrid Automatic Repeat reQuest (HARD) process number corresponding to the delivery acknowledgment signal.

13. The radio base station according to claim 4, wherein the control section controls allocation of Physical Hybrid-ARQ Indicator Channel (PHICH) resources by applying different offsets to delivery acknowledgment signals, between which the same Physical Resource Block (PRB) index and cyclic shift index are used for uplink data, among the plurality of delivery acknowledgment signals.
